(19) United States
(12) Patent Application Publication
(10) Pub. No.: US 2013/0118532 A1
(43) Pub. Date: May 16, 2013

(54) Two-Soak Wash

(71) Applicants: Lillian Eva Tang Baltsen, Bagsvaerd (DK); Ture Damhus, Copenhagen (DK)

(72) Inventors: Lillian Eva Tang Baltsen, Bagsvaerd (DK); Ture Damhus, Copenhagen (DK)

(73) Assignee: NOVOZYMES A/S, Bagsvaerd (DK)

(21) Appl. No.: 13/810,284

(22) PCT Filed: Aug. 22, 2011
(86) PCT No.: PCT/EP2011/064356

§ 371 Date: Jan. 15, 2013

(30) Foreign Application Priority Data
Aug. 30, 2010 (EP) 10174509.9
Mar. 31, 2011 (EP) 11160579.6

(51) Int. Cl. B08B 3/04

(52) U.S. Cl. CPC B08B 3/04
USPC 134/26

(57) ABSTRACT

The present invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) adding to the object a second soak solution comprising at least one component that is different from any of the components comprised in the soak solution of (a) followed by a second soak period; (c) furthermore adding to the object water to obtain a wash solution followed by a wash period; and (d) rinsing the object; wherein step (b) is conducted either before or after step (c), and wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

### BACKGROUND OF THE INVENTION

1. Field of the Invention

The present invention relates to wash processes for improved cleaning. In particular the invention relates to liquid concentrated two-soak wash processes wherein certain detergent composition components are added separately from the addition of enzymes.

2. Description of the Related Art

In the last decade much effort has been used in the industry to develop detergent compositions suitable for cold wash conditions. Some of the challenges to be faced when the wash temperature is lowered are amongst others that many surfactants are harder to dissolve in cold water and wetting of textile thus becomes more difficult. For those skilled in the art of detergent formulation there is a wide variety of detergent composition components e.g. surfactants available, however the majority of these are specialty chemicals which are not suitable for routine use, in particular not for low cost items such as home laundering products.

Another challenge for developing detergent compositions products for the low temperature area is that the detergent compositions need to perform optimally at both warm and cold wash conditions due to marked expectations. Therefore only chemicals which in their functionality are robust towards a change in temperature will find their way into such products.

Currently available detergent composition products have a higher wash performance at 40° C. as compared to 20° C. and the detergency becomes even worse when the temperature is lowered from 20° C. to 10° C. Thus, so far it has not been possible by chemistry alone to compensate for the decrease in detergency as the wash temperature is lowered.

Certain types of dirt and stains may be difficult to remove in a normal wash process and means of individual stain removal such as pre-spotters have in some cases been applied. However, such treatment involves separate handling of the objects to be cleaned and imposes additional cleaning steps. Examples of boosting or changing currently used wash processes are listed below:

WO07/008,776 relates to a single-dose enzyme tablet for enhancing and/or supplementing the performance of commercially available fabric and dish care products and providing a cleaning benefit. Such benefit is achieved when using a regular or normal wash temperature and a conventional wash cycle time, the wash performance is improved.

WO08/101,958 relates to a method for laundering fabrics, wherein a foam composition comprising enzymes is distributed over fabrics. After a holding period, water and optionally a detergent composition are added and the fabrics are washed under usual washing conditions.

US2008/0276972 relates to a wash cycle for oxidizing agents wherein a first and subsequently a second wash liquor is dispensed into a wash zone. The wash liquors being either detergent wash liquor or oxidizing wash liquor.

The desire to reduce wash temperatures and at the same time maintain at least the same level of wash performance may thus not solely be met or satisfied by exploring how detergent compositions are formulated but rethinking and transformation of current wash processes must also be considered.

The activity of certain detergent composition components is markedly reduced when lowering the temperature and temperature activation at a higher temperature than the wash temperature may be needed. Furthermore, the activity of some detergent composition components may affect or themselves be affected by other components present in the solution, and individual addition of such components during the wash process may be necessary.

It would be advantageous in the art to optimize wash processes whereby stain removal may be improved without simultaneously also reducing the cleaning efficiency and particularly in light of the growing desire to reduce the overall energy consumption.

### SUMMARY OF THE INVENTION

The inventors have developed a wash process comprising a concentrated surfactant and enzyme soak, a second soak with a component that is less compatible with the at least one enzyme, and a main wash and surprisingly found that this concentrated liquid two soak wash process shows a significant increase in stain removal on a very broad range of stains and an improved wash performance in general. The use of selected chemistry for detergent compositions in combination with a changed wash process has shown to improve the wash performance for a range of temperatures and in particular at reduced temperatures. The cleaning efficiency for cold concentrated two soak wash processes has been increased to a level that matches the currently used wash processes at higher temperatures.

Many stains need different kinds of cleaning chemistry and process in order to be removed. This gives a dilemma because often many different kinds of soling are gathered in the same wash load. Detergents for a normal wash are formulated as a compromise in respect to cleaning many different stain types in same process at same time.

In normal wash processes the amount of chemicals used may be increased with a simultaneous increase in wash performance. At a certain level, the cost-benefit balance may no longer be favorable or a plateau may even be reached where further stain removal is not observed, or the detergency is even reduced. It would therefore be desirable to optimize the use of the chemicals added. The concentrated two-soak wash process raises this upper limit and opens for a better wash performance in particular at cold wash conditions. In this wash process currently used chemistry such as commercially available detergents that are formulated with as well as without enzymes may be used and result in increased wash performance.

In a first aspect the invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) adding to the object a second soak solution comprising at least one component that is different from any of the components comprised in the soak solution of (a) followed by a second soak period; (c) furthermore adding to the object water to obtain a wash solution followed by a wash period; and (d) rinsing the object; wherein step (b) is conducted either before or after step (c), and wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

In a second aspect the invention relates to use of the method for cleaning laundry.

### DETAILED DESCRIPTION OF THE INVENTION

The invention relates to a novel wash process which in comparison with a normal wash process has improved wash performance and at the same time provides means for washing at low and/or cold temperatures and for using less detergent and water whereby the overall energy consumption can be reduced.

The wash process not only shows an improved cleaning effect in comparison with a normal wash conducted at the same temperature but surprisingly demonstrates an overall wash performance when conducted at 20° C. that match the level of a “normal heavy duty wash” at 40° C. This effect is observed even on stains that normally changes physical state at reduced or cold temperatures such as lard and sebum and other fatty material that harden and crystallize at cold conditions and melt at warmer (40° C. and above) conditions.

There are many benefits of the method described herein. The concentrated liquid two soakwash process is characterized by reduced energy consumption as compared to a normal wash process due to the improved detergency power at low temperature. The energy for heating wash water is by far the most energy consuming part of the wash process. Due to the concentrated soak period in which the period with agitation or other mechanical action is low the overall wash time may be cut, the total water consumption is decreased and there is less mechanical wear of the object.

### DEFINITIONS

Benchmark:

The terms “Benchmark” or “Benchmark cleaning” in relation to a process of the invention are defined herein as both denoting the cleaning performance resulting from using the same detergent/wash solution as used in the process in question in a normal wash at the same temperature. It is expressed as a delta remission value (see definition below). In the examples the results relating to the benchmark are in most cases shown in column a.

Concentrated Soak Wash Process:

The terms “Concentrated soak wash”, “Concentrated soak-wash process”, “2-stage wash process” and “liquid concentrated soak wash” are defined herein as synonyms. The term “liquid” may be included such as in “liquid concentrated soak wash” to emphasize that soaking is performed by applying to the object a solution and not non-liquid compositions such as foam.

Concentrated Two-Soak Wash Process:

The terms “Concentrated two-soakwash”, “Concentrated two-soak wash process”, “3-stage wash process” and “liquid concentrated two-soak wash” are defined herein as the wash process of the invention. The term “liquid” may also be included such as in “liquid concentrated two soak wash” to emphasize that soaking is performed by applying to the object a solution and not non-liquid compositions such as foam.

Delta Remission Value (ΔRem):

The terms “Delta remission” or “Delta remission value” are defined herein as the result of a reflectance or remission measurement at 460 nm. The swatch is measured with one swatch of similar color as background, preferably a swatch from a repetition wash. A swatch representing each swatch type is measured before wash. The Delta remission is the remission value of the washed swatch minus the remission value of the unwashed swatch.

Normal Wash Process:

The terms “Normal wash” or “Normal wash process” are defined herein as a one-step wash process wherein the object is cleaned by submerging the object in a wash solution during agitation followed by rinsing.

Process-Related Cleaning Index (PRCI):

The term “Process-related Cleaning Index” (at a given temperature) is defined herein as the cleaning performance of the wash process according to the invention at that temperature relative to the cleaning performance of the benchmark. The wash performance of the wash process according to the invention at the given temperature (X° C.) and with the detergent ingredients used is compared to that of a normal wash process conducted at the same temperature (X° C.) and with the same detergent ingredients applied at the same levels in the wash solution, according to the following formula: [PRCI (X° C.)=ΔRem of wash process according to the invention (X° C.)/ΔRem of Normal wash process (X° C.)].

Relative Wash Performance (RWP):

The term “Relative Wash Performance” is defined herein as the wash performance of the wash process according to the invention conducted at a given temperature (X° C.) relative to the wash performance of a normal wash process at 40° C. using the same detergent ingredients at the same levels in the wash solution. RWP is calculated according to the following formula: [RWP (X° C.)=ΔRem of wash process according to the invention (X° C.)/ΔRem of Normal wash process (40° C.)].

### Method of the Invention

The present invention relates to a method for cleaning an object comprising the steps: (a) distributing to the object a first soak solution comprising at least one surfactant and at least one enzyme followed by a first soak period wherein the concentrations of the at least one surfactant and the at least one enzyme are higher relative to their concentrations in a subsequent wash solution; (b) adding to the object a second soak solution comprising at least one component that is different from any of the components comprised in the soak solution of (a) followed by a second soak period; (c) furthermore adding to the object water to obtain a wash solution followed by a wash period; and (d) rinsing the object; wherein step (b) is conducted either before or after step (c), and wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

In some embodiments the invention relates to a method, the wherein the object is fabric/textile.

The wash process may be conducted manually or mechanically in a container or any suitable washing device that may accommodate the object to be cleaned and the soak and wash solutions.

### Soak 1

The object to be cleaned and a soak solution are added to a suitable container or washing device and in a first step the object is soaked in the soak solution. The soak solution is an aqueous solution comprising at least one surfactant and at least one enzyme. The at least one surfactant and the at least one enzyme may be added individually or as a mixture. They may also be added comprised in a fully formulated detergent composition. The at least one enzyme may furthermore be added together with a detergent composition which detergent composition may be formulated with or without enzyme.

The present wash process requires that at least one enzyme is present in the soak solution. In some embodiments there may be at least two, at least three, at least four, at least five, at least six, at least seven, at least eight, at least nine or at least ten enzymes present in the soak solution. Typically a mixture of selected enzymes is used. Selection of enzyme(s) to be included in the soak solution is dependent on the type of stains to be treated. In some embodiments the invention relates to a method, wherein the at least one enzyme is selected from the group consisting of: hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, and amylases, or any combination thereof.

In other embodiments the invention relates to a method, wherein the at least one enzyme is a mixture comprising or consisting of an amylase, acellulase, a lipase and a protease.

Hemicellulases:

Hemicellulases are the most complex group of non-starch polysaccharides in the plant cell wall. They consist of polymers of xylose, arabinose, galactose, mannose and/or glucose which are often highly branched and connected to other cell wall structures. Hemicellulases of the present invention therefore include enzymes with xylanolytiactivity, arabinolytic activity, galactolytic activity and/or mannolytic activity. The hemi-cellulases of the present invention may for example be selected from xylanases (EC3.2.1.8, EC3.2.1.32, and EC3.2.1.136), xyloglucanases (EC3.2.1.4 and EC3.2.1.151), arabinofuranosidases (EC3.2.1.55), acetylxylan esterases (EC3.1.1.72), glucuronidases (EC3.2.1.31, EC3.2.1.56, EC3.2.1.128 and EC3.2.1.139), glucanohydrolase (EC3.2.1.11, EC3.2.1.83 and EC3.2.1.73), ferulic acid esterases (EC3.1.1.73), coumaric acid esterases (EC3.1.1.73), mannanases (EC3.2.1.25; EC3.2.1.78 and EC3.2.1.101), arabinosidase (EC3.2.1.88), arabinanases (EC3.2.1.99), galactanases (EC 3.2.1.89, EC3.2.1.23 and EC3.2.1.164) and lichenases (EC3.2.1.73). This is, however, not to be considered as an exhausting list.

Mannananase is a preferred hemicellulase in relation to the present invention. Mannanases hydrolyse the biopolymers made up of galactomannans. Mannan containing stains often comprise guar gum and locust bean gum, which are widely used as stabilizers in food and cosmetic products. Suitable mannanases include those of bacterial or fungal origin. Chemically or genetically modified mutants are included. In a preferred embodiment the mannanase is derived from a strain of the genus Bacillus, especially Bacillus sp. 1633 disclosed in positions 31-330 of SEQ ID NO:2 or in SEQ ID NO:5 of WO99/64619 (hereby incorporated by reference) or Bacillus agaradhaerens, for example from the type strain DSM 8721. A suitable commercially available mannanase is Mannaway® produced by Novozymes A/S or Purabrite™ produced by Genencor a Danisco division. Xylanase is a preferred hemicellulase in relation to the present invention. A suitable commercially available xylanase is Pulpzyme® HC (available from Novozymes A/S).

Pectinases:

The term pectinase or pectolytic enzyme is intended to include any pectinase enzyme defined according to the art where pectinases are a group of enzymes that catalyze the cleavage of glycosidic linkages. Basically three types of pectolytic enzymes exist: pectinesterase, which only removes methoxyl residues from pectin, a range of depolymerizing enzymes, and protopectinase, which solubilizes protopectin to form pectin (Sakai et al., (1993) Advances in Applied Microbiology vol. 39 pp 213-294). Example of a pectinases or pectolytic enzyme useful in the invention is pectate lyase (EC4.2.2.2 and EC4.2.2.9), polygalacturonase (EC3.2.1.15 and EC3.2.1.67), polymethyl galacturonase, pectin lyase (EC4.2.2.10), galactanases (EC3.2.1.89), arabinanases (EC3.2.1.99) and/or pectin esterases (EC3.1.1.11). Pectinaceous soils or stains may for example be composed of pectate, polygalacturonic acid, and/or pectin which may be esterified to a higher or lower degree. These substrates are common in soils of vegetable origin which may include grass, vegetables such as spinach, beetroot, carrot, tomatoes, fruits such as all types of cherries and berries, peach, apricot, mango, bananas and grapes as well as stains from drinks derived from plant material, such as wine, beer, fruit juices and additionally tomato sauce, jellies or jams without excluding other pectin containing substances.

Suitable pectinolytic enzymes include those described in WO99/27083, WO99/27084, WO00/55309 and WO02/092741. Suitable pectate lyases include those of bacterial or fungal origin. Chemically or genetically modified mutants are included. In a preferred embodiment the pectate lyase is derived from a strain of the genus Bacillus, especially a strain of Bacillus substilis, especially Bacillus subtilis DSM14218 disclosed in SEQ ID NO:2 or a variant thereof disclosed in Example 6 of WO02/092741 (hereby incorporated by reference) or a variant disclosed in WO03/095638 (hereby incorporated by reference). Alternatively the pectate lyase is derived from a strain of Bacillus licheniformis, especially the pectate lyases disclosed as SEQ ID NO:8 in WO99/27083 (hereby incorporated by reference) or variants thereof as described in WO02/06442. Suitable commercially available pectate lyases are Pectaway® or Pectawash® produced by Novozymes A/S.

Amylases:

Common starch containing stains may for example comprise rice, potato, cereals, noodles, pasta and porridge, without excluding other starch containing substances. Starch stains may not always be visible to the naked eye but starch stains tend to act as glue for particulate soils in wash solutions. Amylases prevent the buildup of starch deposits which may cause discoloration on fabrics and starch films on dishes. Amylases comprise e.g. alpha-amylases (EC3.2.1.1), beta-amylases (EC3.2.1.2) and/or glucoamylases (EC3.2.1.3) of bacterial or fungal origin. Chemically or genetically modified mutants of such amylases are included in this connection. Alpha-amylases are preferred in relation to the present invention. Relevant alpha-amylases include, for example, α-amylases obtainable from Bacillus species, in particular a special strain of B. licheniformis, described in more detail in GB1296839.

Examples of useful amylases are the variants described in WO94/02597, WO94/18314, WO96/23873, and WO97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444. Further examples of useful amylases are the alpha-amylases derived from Bacillus sp. he AA560 alpha-amylase derived from Bacillus sp. DSM 12649 disclosed as SEQ ID NO:2 in WO00/60060 (hereby incorporated by reference) and the variants of the AA560 alpha-amylase, including the AA560 variant disclosed in Example 7 and 8 (hereby incorporated by reference). Relevant commercially available amylases include Natalase®, Stainzyme®, Duramyl®, Termamyl®, Termamyl™ Ultra, Fungamyl® and BAN® (all available from Novozymes A/S, Bagsvaerd, Denmark), and Rapidase® and Maxamyl® P (available from DSM, Holland) and Purastar®, Purastar OxAm and Powerase™ (available from Danisco A/S). Other useful amylases are CGTases (cyclodextrin glucanotransferases, EC 2.4.1.19), e.g. those obtainable from species of Bacillus, Thermoanaerobactor or Thermoanaerobacterium.

Cellulases:

Cellulases are primarily used for textile care, such as removal or reduction of fuzz and pills from cotton fabrics, softening, colour clarification, particulate soil removal, dye transfer inhibition and anti-redeposition of soils on cotton fabrics in the wash.

Suitable cellulases include complete cellulases or mono-component endoglucanases of bacterial or fungal origin with anti redeposition effect. Chemically or genetically modified mutants are included. The cellulase may for example be a mono-component or a mixture of mono-component endo-1,4-beta-glucanase often just termed endoglucanases (EC 3.2.1.4). Some xyloglucanases may also have endoglucanases activity and are also considered as suitable cellulases in the present invention. Suitable cellulases are disclosed in U.S. Pat. No. 4,435,307, which discloses fungal cellulases produced from Humicola insolens. Especially suitable cellulases for this invention are cellulases with anti-redeposition effect.

Suitable mono-component endoglucanases may be obtained from one or more of the following species Exidia glandulosa, Crinipellis scabella, Fomes fomentarius, Spongipellis sp., Rhizophlyctis rosea, Rhizomucor pusillus, Phycomyces nitens, and Chaetostylum fresenii, Diplodia gossypina, Microsphaeropsis sp., Ulospora bilgramii, Aureobasidium sp., Macrophomina phaseolina, Ascobolus stictoides, Saccobolus dilutellus, Peziza, Penicillium verruculosum, Penicillium chrysogenum, and Thermomyces verrucosus, Trichoderma reesei aka Hypocrea jecorina, Diaporthe syngenesia, Colletotrichum lagenarium, Xylaria hypoxylon, Nigrospora sp., Nodulisporum sp., and Poronia punctata, Cylindrocarpon sp., Nectria pinea, Volutella colletotrichoides, Sordaria fimicola, Sordaria macrospora, Thielavia thermophila, Syspastospora boninensis, Cladorrhinum foecundissimum, Chaetomium murorum, Chaetomium virescens, Chaetomium brasiliensis, Chaetomium cunicolorum, Myceliophthora thermophila, Gliocladium catenulatum, Scytalidium thermophila, Acremonium sp Fusarium solani, Fusarium anguioides, Fusarium poae, Fusarium oxysporum ssp. lycopersici, Fusarium oxysporum ssp. passiflora, Humicola nigrescens, Humicola grisea, Fusarium oxysporum, Thielavia terrestris or Humicola insolens. One preferred endoglucanase is disclosed in WO96/29397 as SEQ ID NO:9 (hereby incorporated by reference) or an enzyme with at least 70% identity thereto and variants thereof as disclosed in Example 1 of WO98/12307. Another preferred endoglucanase is disclosed in WO91/017243 (SEQ ID NO:2) or endoglucanases variants as disclosed in WO94/007998.

Endoglucanases with an anti-redeposition effect may be obtained from fungal endoglucanases lacking a carbohydrate-binding module (CBM) from a number of bacterial sources. Some sources are Humicola insolens, Bacillus sp. deposited as DSM 12648, Bacillus sp. KSMS237 deposited as FERM P-16067, Panibacillus polymyxa, and Panibacillus pabuli. Specific anti-redeposition endoglucanase are disclosed in WO91/17244 (hereby incorporated by reference), WO04/053039 SEQ ID NO:2 (hereby incorporated by reference), JP2000210081 position 1 to 824 of SEQ ID NO:1 (hereby incorporated by reference).

Xyloglucanases with an anti-redeposition effect may be obtained from a number of bacterial sources. Some sources are Bacillus licheniformis, Bacillus agaradhaerens, (WO99/02663) Panibacillus polymyxa, and Panibacillus pabuli (WO01/62903). Suitable variants of xyloglucasnes are also described in PCT/EP2009/056875. A commercially available xyloglucanase is Whitezyme® (Novozymes A/S).

Commercially available cellulases include Celluclast® produced from Trichoderma reesei, Celluzyme® produced from Humicola insolens. Commercially available endoglucanases are Carezyme®, Renozyme®, Endolase® and Celluclean® (Novozymes A/S), and KAC-500(B)™ (Kao Corporation) and Clazinase™, Puradax™ EG L and Puradax HA (Danisco A/S).

Lipases:

Lipase or a lipolytic enzyme provides improved detergency performance on soils that contain fat or oil. Common fat and/or oil containing stains may for example comprise body soils (sebum), lipstick, mayonnaise, mustard, salad dressings, vegetable fat and oil, animal fat (e.g. butter and gravy), wax and mineral oil without excluding other oil and/or fat containing substances. Any lipase suitable for use in alkaline solutions can be used. Suitable lipases include those of bacterial or fungal origin. Chemically or genetically modified mutants of such lipases are included in this connection. The lipase may for example be triacylglycerol lipase (EC3.1.1.3), phospholipase A2 (EC3.1.1.4), Lysophospholipase (EC3.1.1.5), Monoglyceride lipase (EC3.1.1.23), galactolipase (EC3.1.1.26), phospholipase A1 (EC3.1.1.32), Lipoprotein lipase (EC3.1.1.34). Examples of useful lipases include a Humicola lanuginosa lipase, e.g. as described in EP258068 and EP305216; a Rhizomucor miehei lipase, e.g. as described in EP238023 or from H. insolens as described in WO96/13580; a Candida lipase, such as a C. antarctica lipase, e.g. the C. antarctica lipase A or B described in EP214761; a Pseudomonas lipase, such as one of those described in EP721981 (e.g. a lipase obtainable from a Pseudomonas sp. SD705 strain having deposit accession number FERM BP-4772), in PCT/JP96/00426, in PCT/JP96/00454 (e.g. a P. solanacearum lipase), in EP571982 or in WO95/14783 (e.g. a P. mendocina lipase), a P. alcaligenes or P. pseudoalcaligenes lipase, e.g. as described in EP218272, a P. cepacia lipase, e.g. as described in EP331376, a P. stutzeri lipase, e.g. as disclosed in GB1372034, or a P. fluorescens lipase; a Bacillus lipase, e.g. a B. subtilis lipase (Dartois et al. (1993) Biochemica et Biophysica Acta 1131:253-260), a B. stearothermophilus lipase (JP64/744992) and a B. pumilus lipase (WO91/16422). Other examples are lipase variants such as those described in WO92/05249, WO94/01541, EP407225, EP260105, WO95/35381, WO96/00292, WO95/30744, WO94/25578, WO95/14783, WO95/22615, WO97/04079 and WO97/07202. A preferred lipase variant is that of Humicola lanuginosa DSM 4109 as described in WO00/60063. Especially preferred are the variants disclosed in the Example in WO00/60063 with improved first wash performance i.e., T231R+N233R; G91A+D96W+E99K+G263Q+L264A+1265T+G266D+T267A+L269N+R209P+T231R+N233R; N33Q+D96S+T231R+N233R+Q249R; E99N+N101S+T231R+N233R+Q249R; E99N+N101S+T231R+N233R+Q249R.

Suitable commercially available lipases include Lipex®, Lipolase® and Lipolase Ultra®, Lipolex®, Lipoclean® (available from Novozymes A/S), M1 Lipase™ and Lipomax™ (available from Genencor Inc.) and Lipase P “Amano” (available from Amano Pharmaceutical Co. Ltd.). Commercially available cutinases include Lumafast™ from Genencor Inc.

Cutinases:

Potentially useful types of lipolytic enzymes include cutinases (EC3.1.1.74), e.g. a cutinase derived from Pseudomonas mendocina as described in WO88/09367, or a cutinase derived from Fusarium solani pisi (described, e.g., in WO90/09446). Due to the lipolytic activity of cutinases they may be effective against the same stains as lipases. Commercially available cutinases include Lumafast™ from Genencor Inc.

Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO93/24618, WO95/10602, and WO98/15257. Commercially available peroxidases include Guardzyme™ (Novozymes A/S).

Proteases:

Proteases are used in the removal of protein containing stains such as blood, dairy products, body soils (sebum), baby formula, mud, grass, eggs and baby food. Any protease suitable for use in alkaline solutions can be used. Suitable proteases include those of animal, vegetable or microbial origin. Microbial origin is preferred. Chemically modified or protein engineered mutants are included. The protease may for example be a metalloprotease (EC3.4.17 or EC3.4.24) or a serine protease (EC3.4.21), preferably an alkaline microbial protease or a trypsin-like protease. Examples of alkaline proteases are subtilisins (EC3.4.21.62), especially those derived from Bacillus, e.g., subtilisin Novo, subtilisin Carlsberg, subtilisin 309, subtilisin 147 and subtilisin 168 (described in WO89/06279). Examples of trypsin-like proteases are trypsin (e.g., of porcine or bovine origin) and the Fusarium protease described in WO89/06270 and WO94/25583. Examples of useful proteases are the variants described in WO92/19729, WO98/20115, WO98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274. Commercially available protease enzymes include Alcalase®, Savinase®, Primase®, Duralase®, Esperase®, and Kannase® (Novozymes A/S), Maxatase®, Maxacal®, Maxapem®, Properase®, Purafect®, Purafect OxP®, FN2™, and FN3™ (Genencor International Inc.).

In some embodiments the invention relates to a method wherein the at least one enzyme may be used in addition to detergent compositions in accordance with the invention at a level from 0.000001% to 10%, from 0.00001% to 5%, from 0.0001% to 2.5%, from 0.001% to 2%, from 0.01% to 1.5%, or from 0.1% to 1% of enzyme protein by weight of the composition.

In some embodiments the invention relates to a method wherein the at least one enzyme may be used in addition to detergent compositions in accordance with the invention at an amount from 0 to 20, from 0.00001 to 10, from 0.0001 to 5, from 0.0001 to 2.5, from 0.001 to 2, from 0.01 to 1, from 0.1 to 0.5 milligram enzyme protein per gram textile.

In some embodiments the invention relates to a method wherein the at least one enzyme may be used in addition to detergent compositions in accordance with the invention at a concentration from 0 to 5000, from 0.001 to 100, from 0.01 to 50, or from 0.1 to 10 milligram enzyme protein per liter soak solution.

If a fully formulated detergent such as a commercially available detergent is used such detergent may already comprise enzymes. These enzymes provided by the detergent should not be included in calculations relating to the amount of added enzyme protein or the at least one enzyme. The least one enzyme may in general be understood as the individual enzyme or it may be the sum of all the individual enzymes added. In some embodiments the invention relates to a method wherein the level of enzyme protein by weight of the composition relates to the amount of the individual added enzyme of the at least one enzyme added. In other embodiments the invention relates to a method wherein the level of enzyme protein by weight of the composition relates to the amount of all added enzymes of the at least one enzyme added ie. the total amount of added enzyme.

The concentrated soak wash process also requires the presence of at least one surfactant. In some embodiments the invention relates to a method, wherein the surfactants present are selected from the groups consisting of: anionic surfactants; cationic surfactants; zwitterionic surfactants; ampholytic nonionic surfactants; or any combinations thereof.

Suitable anionic surfactants are soaps and those containing sulfate or sulfonate groups. Surfactants of the sulfonate type that come into consideration are (C9-C13-alkyl)benzenesulfonates and olefinsulfonates, the latter being understood to be mixtures of alkenesulfonates and hydroxyalkanesulfonates and -disulfonates, as obtained, for example, by sulfonation of C12-C18 monoolefins having a terminally or internally located double bond. Also suitable are (C12-C18)alkanesulfonates and esters of alpha-sulfo fatty acids (ester sulfonates), for example the alpha-sulfonated methyl esters of hydrogenated coconut, palm kernel or tallow fatty acids a alpha-sulfocarboxylic acids resulting from saponification of MES may be used.

Further suitable anionic surfactants are sulfonated fatty acid glycerol esters comprising mono-, di- and tri-esters and mixtures thereof.

Alk(en)yl sulfates to which preference is given are the alkali metal salts and the sodium salts of sulfuric acid monoesters of C12-C18 fatty alcohols, for example from coconut fatty alcohol, tallow fatty alcohol, lauryl, myristyl, cetyl or stearyl alcohol, or of C10-C20 oxo alcohols and sulfuric acid monoesters of secondary alcohols having that chain length. From the point of view of washing technology, special preference is given to C12-C16 alkyl sulfates and C12-C15 alkyl sulfates and also to C14-C15 alkyl sulfates. Suitable anionic surfactants are also alkane-2,3-diylbis(sulfates) that are prepared, for example, in accordance with U.S. Pat. No. 3,234,258 or U.S. Pat. No. 5,075,041.

Also suitable are the sulfuric acid monoesters of straight-chain or branched C7-C21 alcohols ethoxylated with from 1 to 6 mole of ethylene oxide, such as 2-methyl-branched C9-C11 alcohols with, on average, 3.5 mole of ethylene oxide (EO) or C12-C18 fatty alcohols with from 1 to 4 EO. Because of their high foaming characteristics, they are normally used in washing and cleaning compositions only at relatively low levels, for example at levels of from 1% to 5% by weight.

Anionic surfactants may also include diesters, and/or salts of monoesters, of sulfosuccinic acid with C8-C18 fatty alcohol residues or mixtures thereof. Special preference is given to sulfosuccinates in which the fatty alcohol residues have a narrow chain length distribution. It is likewise also possible to use alk(en)yl sulfosuccinates having preferably from 8 to 18 C-atoms in the alk(en)yl chain, or salts thereof.

Further anionic surfactants that come into consideration are fatty acid derivatives of amino acids, for example of methyltaurine (taurides) and/or of methylglycine (sarcosides). Further anionic surfactants that come into consideration are soaps. Saturated fatty acid soaps such as the salts of lauric acid, myristic acid, palmitic acid, stearic acid, hydrogenated erucic acid and behenic acid and soap mixtures derived from natural fatty acids, for example coconut, palm kernel or tallow fatty acids. The anionic surfactants, including the soaps, may be present in the form of their sodium, potassium or ammonium salts and in the form of soluble salts of organic bases such as mono-, di- or triethanolamine. The anionic surfactants may be present in the form of their sodium or potassium salts.

In other embodiments the invention relates to a method, wherein the anionic surfactant is a linear alkylbenzenesulfonate; alpha-olefinsulfonate; alkyl sulfate (fatty alcohol sulfate); alcohol ethoxysulfate; secondary alkanesulfonate; alpha-sulfo fatty acid methyl ester; alkyl- or alkenylsuccinic acid; soap; or any combination thereof.

As non-ionic surfactants, preferably alkoxylated, advantageously ethoxylated and/or propoxylated, especially primary alcohols having from 8 to 18 C-atoms and, on average, from 1 to 12 moles of ethylene oxide (EO) and/or from 1 to 10 moles of propylene oxide (PO) per mole of alcohol are used. Special preference is given to C8-C16 alcohol alkoxylates, advantageously ethoxylated and/or propoxylated C10-C15 alcohol alkoxylates, especially C12-C14 alcohol alkoxylates, having a degree of ethoxylation between 2 and 10, or between 3 and 8, and/or a degree of propoxylation between 1 and 6, or between 1.5 and 5. The alcohol residue may be preferably linear or, especially in the 2-position, methyl-branched, or may comprise a mixture of linear and methyl-branched chains, as are usually present in oxo alcohols. Special preference is given, however, to alcohol ethoxylates derived from linear alcohols of natural origin that contain from 12 to 18 C-atoms, for example coconut, palm and tallow fatty alcohol or oleyl alcohol, and on average from 2 to 8 EO per mole of alcohol. The ethoxylated alcohols include, for example, C12-C14 alcohols with 3 EO or 4 EO, C9-C11 alcohols with 7 EO, C13-C15 alcohols with 3 EO, 5 EO, 7 EO or 8 EO, C12-18 alcohols with 3 EO, 5 EO or 7 EO, mixtures thereof, such as mixtures of C12-C14 alcohol with 3 EO and C12-C18 alcohol with 5 EO. The mentioned degrees of ethoxylation and propoxylation represent statistical averages which, for a specific product, can be a whole number or a fractional number. Preferred alcohol ethoxylates and propoxylates have a restricted homologue distribution (narrow range ethoxylates/propoxylates, NRE/NRP). In addition to those non-ionic surfactants, fatty alcohol ethoxylates having more than 12 EO may also be used. Examples thereof are tallow fatty alcohol ethoxylate with 14 EO, 25 EO, 30 EO or 40 EO.

Also suitable are alkoxylated amines, which are ethoxylated and/or propoxylated, especially primary and secondary amines having from 1 to 18 C-atoms per alkyl chain and, on average, from 1 to 12 moles of ethylene oxide (EO) and/or from 1 to 10 moles of propylene oxide (PO) per mole of amine.

In addition, as further non-ionic surfactants, there may also be used alkyl polyglycosides of the general formula R₁O(G)ₓ, wherein R₁ is a primary straight-chain or methyl-branched (especially methyl-branched in the 2-position) alkyl group having from 8 to 22, preferably from 12 to 18, C-atoms and the symbol ‘G’ indicates a glycose (monosaccharide) unit having 5 or 6 C-atoms; preferably G is glucose. The degree of oligomerisation x, which indicates the average number of glycose units, will generally lie between 1 and 10; x is preferably from 1.2 to 1.4.

A further class of used non-ionic surfactants, which are used either as sole non-ionic surfactant or in combination with other non-ionic surfactants, comprises alkoxylated, preferably ethoxylated or ethoxylated and propoxylated fatty acid alkyl esters, having from 1 to 4 C-atoms in the alkyl chain, especially fatty acid methyl esters, as described, for example, in JP58/217598.

Non-ionic surfactants of the amine oxide type, for example N-(coco alkyl)-N,N-dimethylamine oxide and N-(tallow-alkyl)-N,N-bis(2-hydroxyethyl)amine oxide, and of the fatty acid alkanolamide or ethoxylated fatty acid alkanolamide type may also be suitable.

In some embodiments the invention relates to a method, wherein the non-ionic surfactant is an alcohol ethoxylate; nonylphenol ethoxylate; alkylpolyglycoside; alkyldimethylamineoxide; ethoxylated fatty acid monoethanolamide; fatty acid monoethanolamide; fatty acid (polyhydroxyalkanol)amide; N-acyl-N-alkyl derivatives of glucosamine (“glucamides”); or any combination thereof.

In some embodiments the invention relates to a method wherein the concentration of the at least one surfactant is from 0 to 500, from 0.00001 to 100, from 0.0001 to 50, from 0.0001 to 40, from 0.001 to 30, from 0.01 to 20, from 0.1 to 15, from 1 to 10 milligram per gram textile.

In some embodiments the invention relates to a method, wherein the concentration of the at least one surfactant is from 0 to 50, from 0.0001 to 40, from 0.001 to 30, from 0.01 to 20 from 0.1 to 10, or from 1 to 5 g per L soak solution.

The concentration of the at least one enzyme and the at least one surfactant are higher relative to their concentrations in the subsequent wash solution.

In some embodiments the invention relates to a method, wherein the concentration of the at least one enzyme in the wash solution is obtained by diluting the soak solution with a factor of at least 1, 2, 3, 4, 5, 6, 7, 8, 9, 10, 11, 12, 13, 14, 15, 16, 17, 18, 19 or 20.

In some embodiments the invention relates to a method, wherein the concentration of the at least one surfactant in the wash solution is obtained by diluting the soak solution with a factor of at least 1, 2, 3, 4, 5, 6, 7, 8, 9, 10, 11, 12, 13, 14, 15, 16, 17, 18, 19 or 20.

### Soak 2

The performance of certain detergent composition components is affected in the presence of other detergent composition components and where the performance is reduced such components may therefore benefit by being separated from each other. It is for example known that bleach components and systems may have a negative impact on the performance of enzymes and the present invention is characterized by comprising a separate soak step, which may be conducted after the enzyme soak and which may occur either before or after the main wash.

Bleaching systems are present in certain detergents to bleach particular stains such as red wine, tea, coffee, fruit juices, grass, carrot, or tomato sauce, whether on clothes or tableware. Bleaching systems also help to maintain the whiteness and brightness of garments. Unfortunately such agents are very dependent on temperature and typically when such agents are employed in cold solutions their performance is decreased. Presence of Bleach components in the detergent formulation can influence the stability other ingredients negatively. So formulating bleach components into a detergent composition is a balance getting performance and not reaching concentrations that can harm the other ingredients.

The application of bleaching systems in a separate step would therefore permit either an increased concentration without affecting the performance of other components present in the solution and/or use of an individual temperature that enable activation of the bleaching system.

At low temperature the wash process of the invention would benefit from an increased temperature of the bleach system for activation. This raise in temperature may be conducted prior to or simultaneously with the addition of the bleach system containing solution whereby the temperature of the wash process according to the invention is affected as little as possible if at all. In some embodiments the invention relates to a method, wherein the activation of the bleach system is performed at a temperature between 15° C. and 50° C., between 20° C. and 45° C., between 25° C. and 40° C., or between 30° C. and 35° C.

Suitable bleaching system components include bleaching catalysts, photobleaches, bleach activators, sources of hydrogen peroxide such as sodium percarbonate and sodium perborates, preformed peracids and mixtures thereof.

Suitable photobleaches may for example be sulfonated zinc phthalocyanine.

Suitable preformed peracids include, but are not limited to, compounds selected from the group consisting of peroxycarboxylic acids and salts, percarbonic acids and salts, perimidic acids and salts, peroxymonosulfuric acids and salts, for example, Oxone (R), and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 C-atoms, or from 8 to 12 C-atoms and, when the peracid is hydrophilic, less than 6 C-atoms or even less than 4 C-atoms; and M is a counterion, for example, sodium, potassium or hydrogen.

Sources of hydrogen peroxide, may for example be selected from, inorganic salts, including alkali metal salts such as sodium salts of perborate (usually mono- or tetra-hydrate), percarbonate, persulfate, perphosphate, persilicate salts and mixtures thereof. In one aspect of the invention the inorganic salts are selected from the group consisting of sodium salts of perborate, percarbonate and mixtures thereof.

Suitable bleach activators are of the formula R—(C═O)-L wherein R is an alkyl group, optionally branched, having, when the bleach activator is hydrophobic, from 6 to 14 C-atoms, or from 8 to 12 C-atoms and, when the bleach activator is hydrophilic, less than 6 C-atoms or even less than 4 C-atoms; and L is leaving group. Examples of suitable leaving groups are alkanolates and phenolates and derivatives thereof, one particular example being 4-oxidobenzenesulfonate. Suitable bleach activators include 4-(dodecanoyloxy)benzenesulfonate (LOBS), 4-(decanoyloxy)benzenesulfonate, 4-(decanoyloxy)benzoate (DOBS), 4-(3,5,5-trimethylhexanoyloxy)benzenesulfonate (ISONOBS), tetraacetylethylenediamine (TAED) and 4-(nonanoyloxy)benzenesulfonate (NOBS). Suitable bleach activators are also disclosed in WO98/17767.

In some embodiments the bleach components or systems may be selected from a group consisting of: peroxide-based bleaching systems (“peroxygen” or “oxygen-based”) such as sodium perborate mono- or tetrahydrate (NaBO₃.H₂O or NaBO₃.4H₂O), or sodium percarbonate (2Na₂CO₃. 3H₂O₂); bleach activators such as TAED, NOBS, ISONOBS, LOBS or DOBS, all mentioned above; free peracids such as 6-(phthaloylamino)percapronic acid or 6-(phthalimido)peroxyhexanoic acid (PAP); bleach catalysts such as a mononuclear Schiff-base manganese(III) complex sold under the name Tinocat; photobleaches which are aluminum and zinc complexes of sulfonated phthalocyanine; or any combination thereof.

In some embodiments the bleach component may be an organic catalyst selected from the group consisting of organic catalysts having the following formulae:

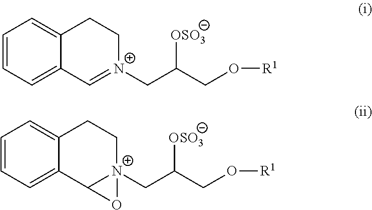

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

The invention is here exemplified by a bleach soak step however the skilled person would know that any detergent composition components where the performance is or will impact other detergent composition components may likewise be subject for a corresponding separate soak step. Without being limiting examples of such components may be e.g. protease and polymers.

During the first soak period and/or the second soak period the water level is relatively low as compared to the water level during wash and the weight to weight ratio of material to water may be from 1:1.8 to 1:6.0, from 1:1.8 to 1:5.5, from 1:1.8 to 1:5.0, from 1:1.8 to 1:4.5, from 1:1.8 to 1:4.0, from 1:1.8 to 1:3.5, from 1:1.8 to 1:3.0, from 1:1.8 to 1:2.5, or from 1:1.7 to 1:2.5.

The soak solution or the soak solution components may be applied to the material by spraying or sprinkling preferably during agitation or other mechanical action in order to maximize even distribution of soak solution, dissolution of the soak solution components as well as securing wetting of all material. Alternatively, the material may be added to a container or washing device wherein the soak solution is present and wherein agitation is applied during or after contact between the soak solution and the material. Once the soak solution has been evenly distributed the soak period is characterized by a holding or stand still period wherein no further agitation is needed. Optionally low mechanical action/agitation may be applied. The content of relatively high concentrations of detergent components such as e.g. surfactants in the soak solution may during agitation result in foam/suds which in too large amounts are difficult to remove and accordingly not desirable. It is therefore necessary initially to apply sufficient agitation in order to secure even distribution of soak solution (components) to the object without simultaneously creating foam/suds. Once even distribution of soak solution (components) to the object is obtained no further agitation is required.

In some embodiments the invention relates to a method, wherein the first soak period and/or the second soak period is from 1 to 120 minutes; from 2 to 60 minutes; from 3 to 30 minutes; from 4 to 15; from 5 to 10 minutes; 10 minutes; 9 minutes; 8 minutes; 7 minutes; 6 minutes; 5 minutes; 4 minutes; 2 minutes; or 1 minute. The first soak period and/or the second soak period constitutes a proportion of the overall soak+wash period which expressed as a soak to soak+wash ratio may be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20.

The concentrated two soak wash process shows improved cleaning effect in comparison with benchmark at reduced temperatures and accordingly, in some embodiments the invention relates to a method, wherein the temperature during the first soak period and/or the second soak period is about 35° C.; about 30° C.; about 25° C.; about 24° C.; about 23° C.; about 22° C.; about 21° C.; about 20° C.; about 19° C.; about 18° C.; about 17° C.; about 16° C.; about 15° C.; about 14° C.; about 13° C.; about 12° C.; about 11° C.; about 10° C.; about 9° C.; about 8° C.; about 7° C.; about 6° C.; or about 5° C. In another embodiment the invention relates to a method, wherein the temperature during the first soak period and/or the second soak period is below 35° C.; below 30° C.; below 25° C.; below 24° C.; below 23° C.; below 22° C.; below 21° C.; below 20° C.; below 19° C.; below 18° C.; below 17° C.; below 16° C.; below 15° C.; below 14° C.; below 13° C.; below 12° C.; below 11° C.; below 10° C.; below 9° C.; below 8° C.; below 7° C.; below 6° C.; or below 5° C.

### Wash

The wash period is characterized by an increased water level and is initiated by addition of water to the soaked material thereby diluting the soak solution. The weight to weight ratio of material to water is increased to a level from 1:3.5 to 1:6.5, from 1:4 to 1:5, or from 1:4 to 1:2.

Agitation or mechanical action similar to a normal wash is applied. It is preferred to use medium to high agitation during the wash period to secure maximum interaction between textile and wash solution. In some embodiments the invention relates to a method, wherein agitation or other mechanical action is applied during the wash period.

This is observed to increase the solubilization of degraded stain material as well as surfactants that are built up on the textile in the former step. A compromise must be made between consumer need for a short wash time and the need for sufficient wash performance. In some embodiments the invention relates to a method, wherein the wash period is from 5 to 120 minutes, from 5 to 90 minutes, from 10 to 60 minutes, from 10 to 30 minutes, from 5 to 20 minutes, from 5 to 15 minutes, or from 10 to 15 minutes.

The concentrated two soak wash process shows in particular improved cleaning effect at reduced temperatures and accordingly, in some embodiments the invention relates to a method, wherein the temperature during the wash period is about 35° C.; about 30° C.; about 25° C.; about 24° C.; about 23° C.; about 22° C.; about 21° C.; about 20° C.; about 19° C.; about 18° C.; about 17° C.; about 16° C.; about 15° C.; about 14° C.; about 13° C.; about 12° C.; about 11° C.; about 10° C.; about 9° C.; about 8° C.; about 7° C.; about 6° C.; or about 5° C. In another embodiment the invention relates to a method, wherein the temperature during the wash period is below 35° C.; below 30° C.; below 25° C.; below 24° C.; below 23° C.; below 22° C.; below 21° C.; below 20° C.; below 19° C.; below 18° C.; below 17° C.; below 16° C.; below 15° C.; below 14° C.; below 13° C.; below 12° C.; below 11° C.; below 10° C.; below 9° C.; below 8° C.; below 7° C.; below 6° C.; or below 5° C.

In some embodiment the invention relates to a method wherein the temperature during the first soak period and/or the second soak period and/or the wash period are selected individually to be similar or different.

### Rinse

Next step is to let the water out and get ready for rinsing the object. The rinse can be done according to the normal rinse method. If a washing device is used then the rinse program present may be used. If a concentrated two soak wash process has been applied wherein the amount of detergent has been reduced then the amount of rinse water needed for sufficient removal of detergent remnants may also be lowered.

### Use

The method may be applied for cleaning objects within the field of home care cleaning as well as in the field of industrial cleaning. In some embodiments the invention is related to use of the method for cleaning fabric and/or textile. In other embodiments the invention is related to use of the method for cleaning laundry.

The invention is further described by the following examples that should not be construed as limiting the scope of the invention.

### EXAMPLES

### Materials

Chemicals used as buffers and substrates were commercial products of at least reagent grade.

### Detergent and Enzymes

In the detergent compositions tabulated below, surfactants were added in the form of various commercial products with chain length distributions and degrees of ethoxylation as commonly used in the art when formulating laundry detergents. Enzymes were in some cases comprised in the formulated detergent as indicated.

Detergent enzymes of the classes: proteases, amylases, lipases, cellulases, mannanases and pectinases were variously added, each as a commercial formulated liquid or granulated product. The enzymes, all obtained from Novozymes A/S, Denmark, were used in addition to the detergents in the following examples.

### Swatches

The stained swatches used in the following examples were obtained from Center for Testmaterials BV, Vlaardingen, the Netherlands are listed below in Table I. They have been selected to address stain removal of the most common stains. The swatches may be divided into groups according to the nature of the stain and thus their main sensitivity: Surfactant sensitive stains; enzyme specific sensitive stains like protease, lipase, cellulase, mannanase or amylase; bleach sensitive stains and tracer swatches sensitive to redeposition.

For small scale (Terg-o-tometer, TOM) one of each selected stained swatch were used per wash and ballast up to 20 g of 50% cotton (Wfk 10A) and 50% polyester (Wfk 30A). Swatch size for example 1 is 3.5×3.5 cm and swatch size for example 2 is 5×5 cm.

TABLE I
Stained swatches

| Swatch | Stain | Textile |
|---|---|---|
| Wft 10D | Pigment, sebum | Cotton |
| Wfk 20MU | Make-up | Polycotton |
| EMPA 106 | Mineral oil/carbon black | Cotton |
| CS-101 | Blood slightly aged | Cotton |
| EMPA 116 | Blood/milk/ink | Cotton |
| EMPA 164 | Grass | Cotton |
| CS-20 | Tomato on cotton | Cotton |
| CS-60 | Spaghetti sauce with beef | Cotton |
| EMPA 114 | Red wine | Cotton |
| EMPA 167 | Tea | Cotton |
| wfk 10J | Tea | Cotton |
| wfk 10U | Curry on cotton | Cotton |
| wfk10WB | Blueberry juice | Cotton |
| CS-28 | Rice starch | Cotton |
| C-H097 | Cocoa/oat flakes | Cotton |
| EMPA 112 | Milk/cocoa | Cotton |
| wfk 10A | — | 100% white cotton pre-washed |
| wfk 30A | — | 100% white polyester pre-washed |
| Equest | Tomato Puree | White Knitted Cotton |
| Equest | Paprika | White Knitted Cotton |
| C-S-15 | Bill(blue)berry juice | Cotton |
| Equest | Black Tea | White Knitted Cotton |
| Equest | HP Brown sauce | White Knitted Cotton |
| Equest | Uncle Ben's Madras (Curry) | White Knitted Cotton |
| Equest | H/Pride BBQ Cook In Sauce | White Knitted Cotton |
| CS-44 014 | Chocolate drink pure | Cotton |
| Equest | Frijj Chocolate Milk | White Knitted Cotton |
| Equest | Rubbed Grass | White Knitted Cotton |
| Equest | Ragu | White Knitted Cotton |
| CH007 | Blood | Cotton |
| Equest | Häagen Dazs Belgian Chocolate Ice Cream | White Knitted Cotton |
| Equest | (Heinz) Salad Creme Dressing | Cotton |
| Equest | Sandy Clay | White Knitted Cotton |
| Equest | Arable clay | White Knitted Cotton |
| Equest | (Heinz) Sun Dried Tomato Dipping Sauce | White Knitted Cotton |
| Equest | Beef Dripping | Blue Knitted Cotton |
| Equest | MF SeamLess Liquid Makeup 03 Natural | White Knitted Cotton |
| Equest | DMO (Dirty Motor Oil) | White Knitted Cotton |
| Equest | (Hipp Organic) Carrot & Potato Baby Food | White Knitted Cotton |

### Evaluation of Stains

Wash performance is expressed as a delta remission value (ΔRem). After washing and rinsing the swatches were spread out flat and allowed to air dry at room temperature over night. Light reflectance evaluations of the swatches were done using a Macbeth Color Eye 7000 reflectance spectrophotometer with very small aperture. The measurements were made without UV in the incident light and remission at 460 nm was extracted. Measurements were made on unwashed and washed swatches. The test swatch to be measured was placed on top of another swatch of same type and color (twin swatch). Since there was only one swatch of each kind per beaker, a swatch from a replicate wash was used in this way. Remission values for individual swatches were calculated by subtracting the remission value of the unwashed swatch from the remission value of the washed swatch. The total wash performance for each stained swatch set was calculated as the sum of individual ΔRem.

### Example 1

### Comparison of 3-Stage, 2-Stage and Normal Wash Processes in a Terg-o-Tometer (TOM) Trial

In this trial, a simply composed wash solution without and with added enzymes and without and with an added bleaching agent was applied to a soiled-textile wash load in three different process types: a normal wash process; a 2-stage process in which surfactant and enzymes (if added) were allowed to act first at high levels in a small volume in a soak stage, after which the liquor was diluted and a normal wash was executed; and finally 3-stage processes in which the first soak stage as described above was followed by a second soak stage in which the bleaching agent (peroxyacetic acid), if used, was added and then the normal wash as the third stage, or followed by the wash and then the second soak as the third stage. All these process types were completed with a rinse at the end.

Table 1A and 1B give an overview of the volumes of soak or wash liquor present at the various stages of the various processes and the concentrations of the ingredients present. Following the tables, a more detailed description of each of the processes is given. In all treatments, pH was kept close to 8.8.

TABLE 1A
Volumes and concentrations of ingredients¹⁾ at each stage of the processes investigated

| | | 3-stage²⁾ | | |
|---|---|---|---|---|
| | | Concentration | 3-stage²⁾ | |
| | 2- and 3-stage | in soak stage 2 | Concentration | all processes |
| | Concentration in | if no PAA | in soak stage 2 | Concentration in |
| Process(es) | soak stage 1 | added | if PAA is added | wash stage |
| Total volume | 30 mL | 40 mL⁵⁾ | 45 mL⁵⁾ | 480 mL |
| Ingredients | | | | |
| linear alkyl- | 8.3 g/L | 6.2 g/L | 5.5 g/L | 0.52 g/L |
| benzenesulfonic acid | | | | |
| (LAS), sodium salt | | | | |
| diethanolamine (DEA)³⁾ | — | 125 mM⁶⁾ | 111 mM⁷⁾ | 10 mM |
| enzymes | if added, at levels | enzymes never | enzymes never | if added here, at |
| | specified in Table | added in soak 2 | added in soak 2 | levels specified in |
| | 1B | | | Table 1B as mg |
| | | | | per g textile |
| peroxyacetic acid | — | — | 21.5 mM⁸⁾ | 2.0 mM if added |
| (PAA)⁴⁾ | | | | before wash |
| sodium carbonate | — | — | 43 mM⁹⁾ | 4.0 mM if added |
| | | | | before wash |

¹⁾Water hardness of all solutions used in this example was adjusted with calcium chloride, magnesium chloride, and sodium hydrogencarbonate to 15°dH with molar ratios of Ca/Mg/NaHCO3 = 4:1:7.5 unless otherwise indicated.
²⁾When soak stage 2 was placed after the wash stage, the volumes and the DEA, PAA and sodium carbonate concentrations were different, as specified below.
³⁾Added as a solution of DEA with pH adjusted to 8.8 with sulfuric acid.
⁴⁾PAA was added as a commercially available solution containing peroxyacetic acid, acetic acid, and hydrogen peroxide. This solution was highly acidic, and the sodium carbonate was added for pH adjustment.
⁵⁾When soak stage 2 was placed after the wash stage, this volume was approx 35 mL.
⁶⁾When soak stage 2 was placed after the wash stage, this concentration was 500 mM.
⁷⁾When soak stage 2 was placed after the wash stage, this concentration was 428 mM.
⁸⁾When soak stage 2 was placed after the wash stage, this concentration was 27.6 mM.
⁹⁾When soak stage 2 was placed after the wash stage, this concentration was 55 mM.

TABLE 1B
Amounts of Surfactant and Enzymes used

| | g per L soak liquor | |
|---|---|---|
| | in soak stage 1 | g per g textile |
| total surfactants | 8.3 | 0.013 |

| added enzymes | | mg active enzyme | mg active enzyme |
|---|---|---|---|
| according to | | protein per L soak | protein per g |
| invention | Product | liquor | textile |
| Protease | Savinase 16 L | 62.4 | 0.096 |
| Amylase | Stainzyme 12.0 L | 29.3 | 0.045 |
| Lipase | Lipex 100 L | 15.0 | 0.023 |
| cellulase | Celluclean 5.0 T | 9.1 | 0.014 |

### 3-Stage Process

Soak 1 is carried out in a beaker (approx. 1 L) placed in a water bath at 20° C. The stained swatches and the ballast textile are added successively to the 30 mL soak solution containing LAS, and enzymes as applicable (cf. Table 1A), and carefully wetted by gently turning them with a dough scraper. This takes 30 sec. They are then left to soak for 4 min after which they are again gently turned with the dough scraper for 30 sec.

The ingredients for soak 2 are then added, increasing the volume to 40 mL or 45 mL as specified in Table 1A. Again the swatches are gently turned using the dough scraper for 30 s and then left to soak for 4.5 min.

All contents of the beaker are then transferred to a TOM beaker and either 440 or 435 mL DEA solution with a hardness of 15° dH are added, as applicable, cf. Table 1A. An ordinary wash process at 120 rpm, at 20° C., is carried out for 10 min in the TOM.

After the wash, the wash liquor is strained off and the swatches rinsed for 5 min in cold tap water.

After the rinse, the swatches are squeezed manually so as to remove most excess water and then placed to dry overnight, protected from light, in a drying cabinet without air circulation. The temperature must be as close to room temperature as possible.

3-Stage Process with Soak Stage 2 at the End

Soak 1 is carried out in a beaker (approx. 1 L) placed in a water bath at 20° C. The stained swatches and the ballast textile are added successively to the 30 mL soak solution containing LAS, and enzymes as applicable (cf. Table 1A), and carefully wetted by gently turning them with a dough scraper. This takes 30 s. They are then left to soak for 4 min after which they are again gently turned with the dough scraper for 30 sec.

All contents of the beaker are then transferred to a TOM beaker and DEA solution and water hardness ingredients are added so as to reach the volume and concentrations specified in the last column of Table 1A. An ordinary wash process at 120 rpm, at 20° C., is carried out for 10 min in the TOM.

The swatches are then drained and squeezed to remove most excess liquid, and thereafter diethanolamine, and PAA+sodium carbonate if applicable, are added to a total volume of added liquid at this stage of 30 mL or 35 mL. The swatches are soaked in this volume for 5 min.

After this, the soak liquor is strained off and the swatches rinsed for 5 min in cold tap water.

After the rinse, the swatches are squeezed manually so as to remove most excess water and then placed to dry overnight, protected from light, in a drying cabinet without air circulation. The temperature must be as close to room temperature as possible.

### 2-Stage Process

Soak 1 is carried out in a beaker (approx. 1 L) placed in a water bath at 20° C. The stained swatches and the ballast textile are added successively to the 30 mL soak solution containing LAS, and enzymes as applicable (cf. Table 1A), and carefully wetted by gently turning them with a dough scraper. This takes 30 sec. They are then left to soak for 4 min after which they are again gently turned with the dough scraper for 30 sec.

All contents of the beaker are then transferred to a TOM beaker, and DEA solution and water with a hardness of 15° dH are added so as to reach a volume of 480 mL and the ingredient levels specified in the last column of Table 1A. An ordinary wash process at 120 rpm, at 20° C., is then carried out for 15 min in the TOM.

After the wash, the wash liquor is strained off and the swatches rinsed for 5 min in cold tap water.

After the rinse, the swatches are squeezed manually so as to remove most excess water and then placed to dry overnight, protected from light, in a drying cabinet without air circulation. The temperature must be as close to room temperature as possible.

### Normal Wash Process

An ordinary wash at 120 rpm, 20° C., is carried out for 20 min in the TOM in 480 mL wash liquor composed according to Table 1A (without or with enzymes). After the wash, the wash liquor is strained off and the swatches rinsed for 5 min in cold tap water.

After the rinse, the swatches are squeezed manually so as to remove most excess water and then placed to dry overnight, protected from light, in a drying cabinet without air circulation. The temperature must be as close to room temperature as possible.

TABLE 1C
ΔRem calculated for swatches washed in Detergent 1.

| | Column | | | | | | | |
|---|---|---|---|---|---|---|---|---|
| | 1b | 1c | 1d | 1e | 1f | 1g | 1h | 1i |
| Detergent No: | 1 | 1 | 1 | 1 | 1 | 1 | 1 | 1 |
| Enzymes | − | + | − | + | − | + | − | + |
| Bleach system | − | − | + | + | − | − | + | + |
| Temperature | 20° C. | 20° C. | 20° C. | 20° C. | 20° C. | 20° C. | 20° C. | 20° C. |
| Wash process | N | N | N | N | 2-S | 2-S | 2-S | 2-S |
| Time | 20 | 20 | 20 | 20 | 5/15 | 5/15 | 5/15 | 5/15 |
| Swatch No: | | | | | | | | |
| wfk 10 D | 10 | 10 | 10 | 12 | 14 | 13 | 15 | 14 |
| wfk 20 MU | 15 | 15 | 16 | 15 | 14 | 15 | 16 | 16 |
| EMPA 106 | 3 | 6 | 4 | 5 | 6 | 6 | 5 | 6 |
| EMPA 116 | 5 | 13 | 0 | 6 | 10 | 16 | 8 | 15 |
| EMPA 164 | 3 | 5 | 9 | 10 | 6 | 13 | 16 | 18 |
| EMPA 114 | 8 | 8 | 10 | 11 | 11 | 9 | 14 | 11 |
| C-S-101 | 10 | 10 | −1 | 2 | 7 | 9 | 3 | 6 |
| wfk 10 J | −6 | −6 | −1 | 0 | 3 | 4 | 8 | 5 |
| EMPA 167 | −2 | −2 | 2 | 3 | −1 | −1 | 6 | 2 |
| wfk 10 U | 11 | 12 | 14 | 14 | 13 | 13 | 16 | 15 |
| CS-20 | 11 | 12 | 13 | 14 | 11 | 12 | 16 | 16 |
| CS-60 | 18 | 22 | 20 | 23 | 18 | 21 | 22 | 23 |
| Wfk 10WB | 17 | 18 | 22 | 22 | 21 | 21 | 26 | 24 |
| CS-28 | 9 | 22 | 9 | 11 | 8 | 25 | 9 | 25 |
| C-H097 | 23 | 36 | 22 | 30 | 22 | 37 | 27 | 37 |
| EMPA 112 | 9 | 14 | 9 | 12 | 9 | 16 | 11 | 22 |
| wfk 10 A | −3 | −3 | −2 | −2 | −4 | −3 | −2 | −2 |
| wfk 30 A | −2 | −2 | −1 | −1 | −2 | −2 | −1 | −1 |
| TOTAL | 139 | 190 | 156 | 187 | 166 | 224 | 215 | 253 |
| PRCI | 1.00 | 1.00 | 1.00 | 1.00 | 1.19 | 1.18 | 1.38 | 1.35 |
| | Column | | | | | | | |
| | 1j | 1k | 1l | 1m | 1n | 1o | 1p | 1q |
| Detergent No: | 1 | 1 | 1 | 1 | 1 | 1 | 1 | 1 |
| Enzymes | − | + | − | + | − | + | − | + |
| Bleach system | − | − | + | + | − | − | + | + |
| Temperature | 20° C. | 20° C. | 20° C. | 20° C. | 20° C. | 20° C. | 20° C. | 20° C. |
| Wash process | 3-S | 3-S | 3-S | 3-S | 3-S | 3-S | 3-S | 3-S |
| Time | 5/5/10 | 5/5/10 | 5/5/10 | 5/5/10 | 5/10/5 | 5/10/5 | 5/10/5 | 5/10/5 |
| Swatch No: | | | | | | | | |
| wfk 10 D | 12 | 14 | 14 | 16 | 12 | 13 | 12 | 15 |
| wfk 20 MU | 14 | 14 | 15 | 15 | 14 | 15 | 14 | 15 |
| EMPA 106 | 5 | 4 | 5 | 6 | 5 | 6 | 4 | 4 |
| EMPA 116 | 10 | 21 | 9 | 15 | 9 | 17 | 10 | 17 |
| EMPA 164 | 9 | 20 | 22 | 27 | 7 | 15 | 9 | 16 |
| EMPA 114 | 11 | 10 | 16 | 16 | 10 | 9 | 11 | 11 |
| C-S-101 | 10 | 13 | 5 | 6 | 9 | 12 | 9 | 10 |
| wfk 10 J | 4 | 2 | 6 | 7 | 0 | 1 | 4 | 2 |
| EMPA 167 | −1 | −1 | 8 | 12 | −1 | −1 | 4 | 2 |
| wfk 10 U | 12 | 12 | 16 | 16 | 11 | 12 | 12 | 13 |
| CS-20 | 14 | 17 | 19 | 19 | 13 | 15 | 14 | 15 |
| CS-60 | 19 | 23 | 23 | 25 | 19 | 22 | 20 | 24 |
| Wfk 10WB | 22 | 23 | 28 | 31 | 20 | 22 | 23 | 23 |
| CS-28 | 8 | 26 | 8 | 25 | 8 | 27 | 9 | 27 |
| C-H097 | 24 | 40 | 23 | 32 | 25 | 35 | 22 | 37 |
| EMPA 112 | 9 | 26 | 10 | 17 | 8 | 20 | 9 | 18 |
| wfk 10 A | −3 | −4 | −2 | −3 | −3 | −4 | −2 | −3 |
| wfk 30 A | −1 | −1 | 0 | 0 | −1 | −2 | −1 | −1 |
| TOTAL | 178 | 259 | 226 | 282 | 164 | 233 | 183 | 244 |
| PRCI | 1.28 | 1.36 | 1.45 | 1.51 | 1.17 | 1.23 | 1.17 | 1.30 |

Column 1b shows the result of a Normal wash at 20° C. with Detergent 1.
Column 1c shows the result of a Normal Wash at 20° C. with Detergent 1 + Enzymes.
Column 1d shows the result of a Normal wash at 20° C. with Detergent 1 + Bleach.
Column 1e shows the result of a Normal wash at 20° C. with Detergent 1 + Enzymes + Bleach.
Column 1f shows the result of a 2-Stage wash at 20° C. with Detergent 1.
Column 1g shows the result of a 2-Stage Wash at 20° C. with Detergent 1 + Enzymes.
Column 1h shows the result of a 2-stage wash at 20° C. with Detergent 1 + Bleach.
Column 1i shows the result of a 2-stage wash at 20° C. with Detergent 1 + Enzymes + Bleach.
Column 1j to 1m have a second soak step with bleach before the main wash.
Column 1j shows the result of a 3-Stage wash at 20° C. with Detergent 1.
Column 1k shows the result of a 3-Stage Wash at 20° C. with Detergent 1 + Enzymes.
Column 1l shows the result of a 3-Stage wash at 20° C. with Detergent 1 + Bleach.
Column 1m shows the result of a 3-Stage wash at 20° C. with Detergent 1 + Enzymes + Bleach.
Column 1n to 1q have a second soak step with bleach after the main wash.
Column 1n shows the result of a 3-Stage wash at 20° C. with Detergent 1.
Column 1o shows the result of a 3-Stage Wash at 20° C. with Detergent 1 + Enzymes.
Column 1p shows the result of a 3-Stage wash at 20° C. with Detergent 1 + Bleach.
Column 1q shows the result of a 3-Stage wash at 20° C. with Detergent 1 + Enzymes + Bleach.

Conclusion

The 3-stage wash process provides an improved cleaning in comparison with benchmark irrespective of the absence or the presence of enzymes and/or bleach as apparent from the Process Related Cleaning Index (PRCI) values. The 3-stage wash has not only an improved cleaning effect in comparison with benchmark but demonstrates an improved cleaning effect over the 2-stage wash. It is furthermore shown that a better cleaning effect is obtained in 3-stage wash when bleach in soak 2 is conducted before the wash step rather than when bleach in soak 2 is conducted after the wash step. In all experiments the visible redeposition was detected on tracer swatches and the level of redeposition resulting from the 3-stage wash processes was as in the normal wash processes.

### Example 2

### Full-Scale Normal, 2-Stage and 3-Stage Washes

Detergent 2 is a liquid formulation with a pH around 7.9 to 8.0 which comprises enzymes. For each wash an amount of 50 g detergent composition as listed below were used.

TABLE 2A
Detergent 2 composition

| | content in |
|---|---|
| | detergent |
| | composition |
| | by weight (%) |
| | of active |
| | substance |
| | specified |
| surfactants | |
| linear alkylbenzenesulfonate, sodium salt | 3.9 |
| alkylethoxysulfate, sodium salt | 23.1 |
| soap, sodium salt | 3.3 |
| Alcohol ethoxylate | 7.2 |
| dodecyldimethylamine oxide | 1.8 |
| total surfactants | 39.3 |
| water | 41.9 |
| ethanol | 2.8 |
| propane-1,2-diol (MPG) | 3.7 |
| 2-aminoethan-1-ol (MEA) | 1.4 |
| 2,2′-oxydi(ethan-1-ol) (DEG) | 2.7 |
| trisodium citrate dihydrate | 4.8 |
| disodium tetraborate pentahydrate (borax) | 0.9 |
| sodium sulfate (anhydrous) | 0.1 |
| sodium chloride | 0.2 |
| diethylenetriaminepentakis(methylene)pentaphosphonic | 0.3 |
| acid (DTMPA), sodium salt | |
| sodium poly(acrylate) | 0.2 |
| poly(oxyethylene) (PEG) | 0.8 |
| 4,4′-bis[(4-anilino-6-morpholino-1,3,5-triazine-2- | 0.1 |
| yl)amino]stilbene-2,2′-disulfonic acid, sodium salt | |
| enzymes | |
| protease | 0.018 |
| amylase | 0.009 |
| cellulase | 0.00045 |
| mannanase | 0.0015 |

TABLE 2B
Amount of Surfactant and Enzyme used

g per L
soak liquor
in soak stage 1

| | 2-stage | 3-stage | |
|---|---|---|---|
| | process | process | g per g textile |
| total surfactants | 4.9 | 3.9 | 0.0076 |

| | | mg active enzyme | | |
|---|---|---|---|---|
| | | protein per L soak | | |
| | | liquor in soak | | |
| added enzymes | | stage 1 | | mg active enzyme |
| according to | | 2-stage | 3-stage | protein per g |
| invention | Product | process | process | textile |
| protease | Savinase 16 L | 10.6 | 8.5 | 0.016 |
| amylase | Stainzyme 12.0 L | 4.9 | 3.9 | 0.0075 |
| lipase | Lipex 100 L | 0.78 | 0.62 | 0.0012 |
| cellulase | Celluclean 5.0 T | 1.5 | 1.2 | 0.0023 |
| mannanase | Mannaway 4.0 L | 3.2 | 2.5 | 0.0049 |

| BALLAST FABRIC | TYPE | AMOUNT |
|---|---|---|
| T-shirts (jersey) | Cotton | 6 |
| Shirts | Polyester | 8 |
| Towel | Cotton | 3 |

Ballast fabric was added to the test swatches up to a total amount of 2.6 kg. Water hardness of the solutions used in the following experiments was adjusted to 6°dH (Ca:Mg:NaHCO3, 2:1:4.5) unless otherwise indicated.

Front Load Washing Device:

The Miele Profitronic PW 61601 is not designed for wash with low water volumes such as the concentrated soak wash. Suitable wash programs were designed using the Profitronic M1.1.214 software. Programs for a normal wash process, concentrated soak wash, as well as programs for Rinse 1 and Rinse 2 are outlined below. The two rinse programs using cold tap water (22° dH) were applied in all wash processes.

Miele Profitronic PW6101 Wash Programs:

| Normal wash program | 2-stage wash program |
|---|---|
| Miele Profitronic PW6101 Program 1 | Miele Profitronic PW6101 Program 2. |
| Block data Area 2 Block 1, Main wash: | Block data Area 2 Block 1, Main wash: |
| 1) Block activation: Permanent | 1) Block activation: Permanent |
| 2) Programme stop 1: No | 2) Programme stop 1: No |
| 3) Programme stop signal 1: No | 3) Programme stop signal 1: No |
| 4) Heating: Yes | 4) Heating: Yes |
| 5) Freely selectable temperature/parameter: Yes | 5) Freely selectable temperature/parameter: Yes |
| 6) Temperature: Cold | 6) Temperature: Cold |
| 7) Hysteresis: Normal | 7) Hysteresis: Normal |
| 8) Warm up: No | 8) Warm up: No |
| 9) Level 1: 0 mm wc | 9) Level 1: 0 mm wc |
| 10) Intake path 1: Automatic | 10) Intake path 1: Automatic |
| 11) Dispensing type: No | 11) Dispensing type: No |
| 14) Movement from level, movement level: | 14) Movement from level, movement level: |
| Userdefined, Rhythm: Gentle +, Time: 5:00 min:s, | Userdefined, Rhythm: Normal, Time: 4:00 min:s, |
| Drum speed: Scooping, Start of drum rotation: 0 mm wc | Drum speed: Normal, Start of drum rotation: 0 mm wc |
| 15) Level stop 1: No | 15) Level stop 1: No |
| 16) Wash time 1: Scooping 04:00 min:s Rhythm: Gentle + | 16) Wash time 1: 0 U/min 05:00 min:s Rhythm: No |
| 17) Thermostop: No | 17) Thermostop: No |
| 18) Level 2: 0 mm wc | 18) Level 2: 0 mm wc |
| 19) Intake path 2: Automatic | 19) Intake path 2: Automatic |
| 22) Level stop 2: No | 22) Level stop 2: No |
| 23) Wash time 2: Scooping 07:00 min:s Rhythm: Gentle + | 23) Wash time 2: Scooping 07:00 min:s Rhythm: Gentle + |
| 24) Cooling down: No | 24) Cooling down: No |
| 25) Wash time 3: Scooping 04:00 min:s Rhythm: Gentle + | 25) Wash time 3: Scooping 03:00 min:s Rhythm: Gentle + |
| 26) Programme stop 2: No | 26) Programme stop 2: No |
| 27) Programme stop signal 2: No | 27) Programme stop signal 2: No |
| 28) Drain path 1: Drainage | 28) Drain path 1: Drainage |
| 29) Drain level: 0 mm wc | 29) Drain level: 0 mm wc |
| 30) Wash time 4: 0 U/min 00:00 min:s Rhythm: No | 30) Wash time 4: 0 U/min 00:00 min:s Rhythm: No |
| 31) Drain path 2: Drainage | 31) Drain path 2: Drainage |
| 32) Freely selectable spin speed: No | 32) Freely selectable spin speed: No |
| 33) Spin: No | 33) Spin: No |
| 34) Block repetition: Blocks:: No Programmes:: No | 34) Block repetition: Blocks:: No Programmes:: No |
| 35) Block end signal: No | 35) Block end signal: No |
| | Washing |

3-stage wash program
Miele Profitronic PW6101 Program 3.

| Block 1, soak 1 | Block data Area 2 Block 2, soak 2 + mainW: |
|---|---|
| 1) Block activation: Permanent | 1) Block activation: Permanent |
| 2) Programme stop 1: No | 2) Programme stop 1: No |
| 3) Programme stop signal 1: No | 3) Programme stop signal 1: No |
| 4) Heating: Yes | 4) Heating: Yes |
| 5) Freely selectable temperature/parameter: Yes | 5) Freely selectable temperature/parameter: Yes |
| 6) Temperature: Cold | 6) Temperature: Cold |
| 7) Hysteresis: Normal | 7) Hysteresis: Normal |
| 8) Warm up: No | 8) Warm up: No |
| 9) Level 1: 0 mm wc | 9) Level 1: 0 mm wc |
| 10) Intake path 1: Automatic | 10) Intake path 1: Automatic |
| 11) Dispensing type: No | 11) Dispensing type: No |
| 14) Movement from level, movement level: | 14) Movement from level, movement level: |
| Userdefined, Rhythm: Normal, Time: 3:00 min:s, | Userdefined, Rhythm: Normal, Time: 3:00 min:s, |
| Drum speed: Normal. | Drum speed: Normal, |
| Start of drum rotation: 0 mm wc | Start of drum rotation: 0 mm wc |
| 15) Level stop 1: No | 15) Level stop 1: No |
| 16) Wash time 1: 0 U/min 02:00 min:s Rhythm: No | 16) Wash time 1: 0 U/min 01:00 min:s Rhythm: No |
| 17) Thermostop: No | 17) Thermostop: No |
| 18) Level 2: 0 mm wc | 18) Level 2: 0 mm wc |
| 19) Intake path 2: Automatic | 19) Intake path 2: Automatic |
| 22) Level stop 2: No | 22) Level stop 2: No |
| 23) Wash time 2: Scooping 00:00 min:s Rhythm: Gentle + | 23) Wash time 2: Scooping 07:00 min:s Rhythm: Gentle + |
| 24) Cooling down: No | 24) Cooling down: No |
| 25) Wash time 3: Scooping 00:00 min:s Rhythm: Gentle + | 25) Wash time 3: Scooping 03:00 min:s Rhythm: Gentle + |
| 26) Programme stop 2: No | 26) Programme stop 2: No |
| 27) Programme stop signal 2: No | 27) Programme stop signal 2: No |
| 28) Drain path 1: Drainage | 28) Drain path 1: Drainage |
| 29) Drain level: 0 mm wc | 29) Drain level: 0 mm wc |
| 30) Wash time 4: 0 U/min 00:00 min:s Rhythm: No | 30) Wash time 4: 0 U/min 00:00 min:s Rhythm: No |
| 31) Drain path 2: Drainage | 31) Drain path 2: Drainage |
| 32) Freely selectable spin speed: No | 32) Freely selectable spin speed: No |
| 33) Spin: No | 33) Spin: No |
| 34) Block repetition: Blocks:: No Programmes:: No | 34) Block repetition: Blocks:: No Programmes:: No |
| 35) Block end signal: No | 35) Block end signal: No Washing |
| Rinse 1 - Block data Area 3 Block 1 | Rinse 2 - Block data Area 3 Block 2 |
| 1) Block activation: Permanent | 1) Block activation: Permanent |
| 2) Programme stop 1: No | 2) Programme stop 1: No |
| 3) Programme stop signal 1: No | 3) Programme stop signal 1: No |
| 4) Heating: No | 4) Heating: No |
| 5) Freely selectable temperature/parameter: No | 5) Freely selectable temperature/parameter: No |
| 6) Temperature: Cold | 6) Temperature: Cold |
| 7) Hysteresis: Normal | 7) Hysteresis: Normal |
| 9) Level 1: 50 mm wc | 9) Level 1: 50 mm wc |
| 10) Intake path 1: Automatic | 10) Intake path 1: Automatic |
| 11) Dispensing type: No | 11) Dispensing type: No |
| 14) Movement from level, movement level: | 14) Movement from level, movement level: |
| Userdefined, Rhythm: Gentle, Time: 4:00 min:s, | Userdefined, Rhythm: Gentle, Time: 4:00 min:s, |
| Drum speed: Scooping, Start of drum rotation: 50 mm wc | Drum speed: Scooping, Start of drum rotation: 50 mm wc |
| 15) Level stop 1: Yes | 15) Level stop 1: Yes |
| 16) Wash time 1: 0 U/min 00:30 min:s Rhythm: No | 16) Wash time 1: 0 U/min 00:00 min:s Rhythm: No |
| 17) Thermostop: No | 17) Thermostop: No |
| 18) Level 2: 50 mm wc | 18) Level 2: 60 mm wc |
| 19) Intake path 2: Automatic | 19) Intake path 2: Automatic |
| 22) Level stop 2: No | 22) Level stop 2: No |
| 23) Wash time 2: 0 U/min 00:00 min:s Rhythm: No | 23) Wash time 2: 0 U/min 00:00 min:s Rhythm: No |
| 24) Cooling down: No | 24) Cooling down: No |
| 25) Wash time 3: 0 U/min 00:00 min:s Rhythm: No | 25) Wash time 3: 0 U/min 00:00 min:s Rhythm: No |
| 26) Programme stop 2: No | 26) Programme stop 2: Spin stop |
| 27) Programme stop signal 2: No | 27) Programme stop signal 2: Yes |
| 28) Drain path 1: Drainage | 28) Drain path 1: Drainage |
| 29) Drain level: 0 mm wc | 29) Drain level: 0 mm wc |
| 30) Wash time 4: 0 U/min 00:00 min:s Rhythm: No | 30) Wash time 4: 0 U/min 00:00 min:s Rhythm: No |
| 31) Drain path 2: Drainage | 31) Drain path 2: Drainage |
| 32) Freely selectable spin speed: No | 32) Freely selectable spin speed: Yes |
| 33) Spin: No | 33) Spin: Userdefined |
| 34) Block repetition: Blocks:: No Programmes:: No | Spin phase 1: 500 U/min 02:00 min:s Rhythm: No |
| 35) Block end signal: No | Spin phase 2: Normal 00:30 min:s Rhythm: Gentle |
| Washing | Spin phase 3: 1200 U/min 06:00 MIN_0:s Rhythm: No |
| | Spin phase 4: Normal 00:30 min:s Rhythm: Gentle |
| | Spin phase 5: No |
| | Spin phase 6: No |
| | 34) Block repetition: Blocks:: No Programmes:: No |
| | 35) Block end signal: Yes |
| | Washing |

### Normal Wash Process (Full-Scale)

Place the dry ballast fabric and the two tea towels with soiled test swatches into Miele Profitronic PW6101. The temperature of the water is adjusted to 20° C. before use. Water hardness solutions were added to a beaker containing 4000 mL 20° C. deionized water to which detergent 2 was added and agitation applied for 10 min. If enzymes were needed Celluclean was added with the detergent and the other enzymes were added to the beaker just before pouring the wash solution into Miele Profitronic PW6101. Make a further 2×4500 mL deionized water at 20° C. with a water hardness of 6° dH. (If a 40° C. wash is set up then the temperature of the water should be initially approximately 55° C.) Add all 3 beakers of wash solution into the detergent dispenser. The machine is started, and wash program 1 is run for 20 min. Swatches are removed from the machine, cut off the tea towels and placed for drying.

### 2-Stage Wash Process (Full-Scale)

The temperature of the water is adjusted to 20° C. before use. Water hardness solutions were added to a beaker containing 4000 ml 20° C. deionized water to which detergent 2 was added and agitation applied for 10 min. If enzymes were needed, Celluclean was added with the detergent and the other enzymes were added to the beaker just before pouring the wash solution into Miele Profitronic PW6101.

Soak:

Split the dry ballast fabric into three parts. Place one part in a 100 L clear plastic bag and place the first tea towel with soiled test swatches on top and pour over with 1.5 L soak solution. Add the second part of ballast fabric on top and place the second tea towel with soiled test swatches thereon and pour over with 1.5 L soak solution. Add the third part of ballast fabric and wet with the last 1 L soak solution. Close the bag securely with an electrician plastic strip, leaving some air in the bag for the load to be able to mix during soak. Place the bag in Miele Profitronic PW6101 and start program 2. After 9 min the program is stopped.

Wash:

The plastic bag is cut open. The plastic bag with the load, but not the top that are cut off is left in Miele Profitronic PW6101. Add 1×4000 mL and 1×5000 mL 20° C. deionized water with a water hardness of 6° dH. Continue program 2. Swatches are removed from the machine, cut off the tea towels and placed for drying.

### 3-Stage Wash Process (Full-Scale)

The full amount of the detergent chosen is added to 5 L water of 20° C. In case an enzyme cocktail is to be added, the Celluclean granulate is added immediately, under stirring, to the above detergent solution, and after 8.5 min stirring the other enzyme preparations are added.

Ballast and Test Swatch Wetting:

One third of the ballast and one of the tea towels with test swatches are placed in a large plastic bag. Then 2 L of the detergent±enzyme solution prepared above is poured over so as to moisten all swatches. Another third of the ballast and the second tea towel with test swatches are then placed in the bag and a further 2 L of the detergent±enzyme solution poured over so as to moisten all test swatches. The remaining third of the ballast is finally placed on top and the last 1 L of detergent±enzyme solution poured over. The bag is closed securely with an electrician plastic strip making sure to leave some air together with the fabrics inside.

First Soak Stage:

The bag is placed in the machine and program 3 run “Block 1, soak 1” for 5 min.

Second Soak Stage:

The top of the bag is cut off and 2.5 L water of 20° C., prepared according to the desired hardness recipe (as above) and containing 26 mmol peroxyacetic acid (obtained by adding the appropriate amount of the commercially available mixture mentioned in Example 1, this time with no extra carbonate), if applicable, are poured into the bag, which is once again closed securely with an electrician plastic strip making sure to leave some air together with the fabrics inside.

Program 3 “Block data Area 2 Block 2, soak 2+mainW” is started again and run for 4 min.

The top of the bag is cut off and the contents emptied into the machine by turning the inside out on the bag. The bag stays in the machine.

Wash Stage:

The machine is closed and 5.5 L more of water of 20° C., prepared according to the desired hardness recipe (as above), is pumped into the machine.

Program 3 “Block data Area 2 Block 2, soak 2+mainW” is started again and run for another 10 min.

Swatches are removed from the machine, cut off the tea towels and placed for drying.

TABLE 2C
ΔRem calculated for swatches washed in Detergent 2.

| | Column | | | | | | | | | |
|---|---|---|---|---|---|---|---|---|---|---|
| | 2aa | 2ab | 2b | 2c | 2d | 2e | 2f | 2g | 2h | 2i |
| Detergent No: | 2 | 2 | 2 | 2 | 2 | 2 | 2 | 2 | 2 | 2 |
| Enzymes | − | − | − | + | − | + | − | + | − | + |
| Bleaching | − | + | − | − | + | + | − | − | + | + |
| system | | | | | | | | | | |
| Temperature | 40° C. | 40° C. | 20° C. | 20° C. | 20° C. | 20° C. | 20° C. | 20° C. | 20° C. | 20° C. |
| Wash process | N | N | N | N | N | N | 2-S | 2-S | 3-S | 3-S |
| Swatch No: | | | | | | | | | | |
| Tomato Puree | 39 | 24 | 34 | 34 | 28 | 31 | 29 | 41 | 41 | 35 |
| Paprika | 24 | 13 | 18 | 14 | 14 | 16 | 15 | 20 | 18 | 18 |
| Bill(blue)berry | 26 | 31 | 21 | 20 | 24 | 25 | 22 | 21 | 26 | 28 |
| juice | | | | | | | | | | |
| Black Tea | 13 | 32 | 11 | 12 | 19 | 20 | 16 | 16 | 22 | 30 |
| HP Brown sauce | 56 | 31 | 51 | 53 | 25 | 28 | 50 | 53 | 52 | 54 |
| Uncle Ben's | 33 | 12 | 23 | 22 | 12 | 15 | 25 | 28 | 23 | 18 |
| Madras (Curry) | | | | | | | | | | |
| H/Pride BBQ | 31 | 16 | 25 | 30 | 14 | 15 | 29 | 29 | 25 | 25 |
| Cook In Sauce | | | | | | | | | | |
| Chocolate drink | 12 | 10 | 11 | 10 | 8 | 9 | 10 | 12 | 13 | 15 |
| Frijj Chocolate | 46 | 12 | 46 | 49 | 10 | 9 | 44 | 49 | 49 | 55 |
| Milk | | | | | | | | | | |
| Rubbed Grass | 34 | 15 | 23 | 27 | 12 | 14 | 16 | 35 | 27 | 30 |
| Ragu | 37 | 24 | 21 | 26 | 18 | 28 | 28 | 28 | 26 | 22 |
| Blood | 40 | 5 | 51 | 50 | 7 | 10 | 49 | 51 | 38 | 37 |
| Haaged Dazs | 41 | 37 | 37 | 54 | 36 | 38 | 43 | 49 | 43 | 55 |
| Chocolate Ice | | | | | | | | | | |
| Cream | | | | | | | | | | |
| (Heinz) Salad | 27 | 25 | 26 | 28 | 25 | 26 | 26 | 27 | 27 | 29 |
| Creme Dressing | | | | | | | | | | |
| Sandy Clay | 2 | 5 | 2 | 3 | 4 | 4 | 4 | 5 | 5 | 8 |
| Arable clay | 11 | 9 | 10 | 12 | 9 | 10 | 10 | 12 | 11 | 14 |
| (Heinz) Sun Dried | 47 | 31 | 41 | 39 | 34 | 37 | 37 | 47 | 42 | 37 |
| Tomato Dip | | | | | | | | | | |
| Sauce | | | | | | | | | | |
| Beef Dripping on | 7 | 14 | 8 | 7 | 10 | 10 | 8 | 10 | 12 | 13 |
| Blue | | | | | | | | | | |
| MF SeamLess | 31 | 19 | 12 | 11 | 21 | 19 | 17 | 17 | 22 | 40 |
| Liquid Makeup 03 | | | | | | | | | | |
| DMO (Dirty Motor | 21 | 23 | 25 | 26 | 22 | 23 | 25 | 26 | 25 | 32 |
| Oil) | | | | | | | | | | |
| (Hipp Organic) | 37 | 19 | 31 | 30 | 18 | 21 | 26 | 33 | 34 | 32 |
| Carrot & Potato | | | | | | | | | | |
| Baby Food | | | | | | | | | | |
| Standard cotton | 0 | 0 | −1 | 0 | 0 | 0 | 0 | 0 | 0 | 1 |
| Standard | 0 | 1 | −1 | 0 | 0 | −1 | 0 | 0 | 0 | 0 |
| Polyester | | | | | | | | | | |
| TOTAL | 616 | 407 | 525 | 558 | 373 | 407 | 530 | 608 | 581 | 629 |
| RWP | 1.00 | 1.00 | 0.85 | — | 0.92 | — | 0.86 | — | 1.43 | — |
| PRCI | — | — | 1.00 | 1.00 | 1.00 | 1.00 | 1.01 | 1.09 | 1.56 | 1.55 |

Column 2aa shows the result of a Normal wash at 40° C. with Detergent 2.
Column 2ab shows the result of a Normal Wash at 40° C. with Detergent 2 + Bleach.
Column 2b shows the result of a Normal wash at 20° C. with Detergent 2.
Column 2c shows the result of a Normal wash at 20° C. with Detergent 2 + Enzymes
Column 2d shows the result of a Normal wash at 20° C. with Detergent 2 + Bleach.
Column 2e shows the result of a Normal Wash at 20° C. with Detergent 2 + Enzymes + Bleach.
Column 2f shows the result of a 2-stage wash at 20° C. with Detergent 2.
Column 2g shows the result of a 2-stage wash at 20° C. with Detergent 2 + Enzymes
Column 2h shows the result of a 3-Stage wash at 20° C. with Detergent 2 + Bleach.
Column 1i shows the result of a 3-Stage Wash at 20° C. with Detergent 2 + Enzymes + Bleach.

Conclusion:

The 3-stage wash process provides an improved cleaning in comparison with benchmark irrespective of the absence or the presence of enzymes which is apparent from the Process Related Cleaning Index (PRCI) values. The ΔRem value for a 3-stage wash with bleach conducted at 20° C. match the ΔRem value obtained in a normal wash at 40° C. (581 vs. 407).

### Example 3

### Statistical Analysis of the Wash Method According to the Invention

A series of Terg-o-tometer (TOM) washes was conducted to investigate statistically the effects of exposing various soiled test swatches to a wash process according to the invention, comprising an enzyme soak at low wash liquor:textile ratio and thus high enzyme concentrations, followed by either (1) a concentrated bleach soak in which a bleaching system was further added to the enzyme soak liquor, followed by a wash with a high wash liquor ratio, or (2) an ordinary wash wherein the bleaching ingredients were added together with a high volume of wash liquor. All washes employed a set of 20 soiled 3.5 cm×3.5 cm test swatches and 2 clean tracer swatches of the same size (total weight of these 22 swatches: 5.2 g) and 14.8 g of ballast textile as specified below.

The test swatches were placed in the TOM beaker and a total of 40 mL enzyme soak liquor was poured onto them, composed of 5 mL LAS stock solution, 5 mL sodium hydrogencarbonate solution A and 30 mL 15° dH water, all prepared as specified below. The ballast textile was added followed by agitation at 70 rotations per min for 30 s and no agitation for a further 4 min 30 s. Thus, total duration of the enzyme soak was 5 min.

Bleach soak was conducted by adding bleach cocktails on top of the material already present in the TOM beaker (0A or ½A or 1A or 0B or ½B or 1B, all of volume 40 mL, prepared as specified below). Agitation during the bleach soak was 70 rotations per min for 30 s and then no agitation during the remaining time. Duration of the bleach soak was either 5 or 10 min. Following the bleach soak, 520 mL of 15° dH water was added and the main wash conducted at an agitation of 120 rotations per min for 10 or 20 min.

In washes without bleach soak, 560 mL of 15° dH water were added directly after the enzyme soak and the main wash was conducted at an agitation of 120 rotations per min for 10 or 20 min.

The final total volume was in all cases 600 mL. The total wash time was 5 min+0/5/10 min+10/20 min corresponding to 15, 20, 25, 30 or 35 min. The temperature was 20° C.

After washing the textiles were separated from the wash liquor using a strainer and the test swatches separated manually from the ballast and rinsed in a large beaker under running cold tap water for 5 min. The test swatches were then placed on absorbent paper and left to dry overnight in the dark in a drying cabinet with air circulation and a temperature between 25 and 30° C.

Evaluation of the test swatches was conducted by measuring remission at 460 nm on a Macbeth Color Eye 7000 reflectance spectrophotometer, excluding UV light. Each swatch was placed on top of a similar swatch (i.e., a swatch that had undergone a similar wash treatment and had a similar resulting color) as background and measured twice on the front side. The remission values used for further calculations were the average of these two readings. Unwashed swatches of the same batch were also measured and Δremission values were calculated in each case by subtracting the remission of the unwashed swatch from that of the washed swatch.

| | No. of |
|---|---|
| Swatch type | swatches included |
| wfk10J, tea on cotton | 2 |
| EMPA167, tea on cotton | 2 |
| wfk10K, coffee | 1 |
| EMPA114, red wine on cotton | 1 |
| CS-3, wine (aged) | 1 |
| wfk10WB, blueberry juice | 2 |
| CS-11, redcurrant juice | 1 |
| wfk10U, curry on cotton | 1 |
| CS-20, tomato | 2 |
| wfk10P, red pepper | 1 |
| CS-60, spaghetti sauce (with beef) | 1 |
| EMPA164, grass on cotton | 2 |
| EMPA116, blood/milk/ink on cotton | 1 |
| C-S-101, blood, slightly aged | 1 |
| EMPA112, milk/cocoa on cotton | 1 |
| wfk10A cotton, prewashed | 1 |
| wfk30A, standard polyester, prewashed | 1 |

The ballast consisted of 7.4 g cotton textile (wfk10A) and 7.4 g polyester textile (wfk30A). Both materials had been prewashed, but separately from each other, twice at 60° C. in IEC-A* detergent ex wfk (3.85 g/L in tapwater, no addition of sodium perborate or TAED, but with a high dosage of amylase: Stainzyme 12L ex Novozymes) and thereafter once at 95° C. with the same detergent (but no added amylase) at the same dosage in water of a hardness of 15° dH, prepared as described below.

Ordinary laboratory chemicals (calcium and magnesium chloride, sodium hydrogencarbonate, sodium carbonate, sodium hydroxide, sodium percarbonate) were of at least reagent grade. TAED was Peractive P (ex Clariant) and NOBS was the material available from AATCC.

LAS Stock Solution: Add 62.5 g Surfac SDBS80 (80% sodium alkylbenzenesulfonate) per L water; pH adjusted to 8.8 with NaOH.

Sodium hydrogencarbonate solution A: Dissolve 3.39 g NaHCO₃ per L water.

Sodium hydrogencarbonate solution B: Dissolve 45 g NaHCO₃ per L water (solution becomes 0.535 M).

Calcium-magnesium stock solution: Dissolve 126 g CaCl₂.2H₂O and 43.5 g MgCl₂.6H₂O per L.

Water of a hardness of 15° dH: Add 2.5 mL calcium-magnesium stock solution prepared as above and 7.5 mL sodium hydrogencarbonate solution B per L of water.

Enzyme cocktail: The enzyme cocktail applied here contained the following five commercial enzyme products ex Novozymes:

| | Active enzyme protein (μg) |
|---|---|
| Enzyme product | per g textile |
| Savinase 16L | 94 |
| Stainzyme 12.0L | 45 |
| Lipex 100L | 6.5 |
| Celluclean 5.0T | 14 |
| Mannaway 4.0L | 0.50 |

Bleach cocktails (controls) 0A and 0B: 40 mL of 15° dH water, added in order to represent the zero bleach level.

Bleach cocktail ½A: Amounts of 314 mg of sodium percarbonate and 68 mg of TAED were added to 40 mL of 15° dH water and were left to react under stirring at ambient temperature for 20 min.

Bleach cocktail 1A: Amounts of 628 mg of sodium percarbonate and 137 mg of TAED (Peractive P ex Clariant) were added to 40 mL of 15° dH water and were left to react under stirring at ambient temperature for 20 min. Preliminary experiments had shown that a maximum concentration of peracetic acid was reached with certainty after this time.

Bleach cocktail ½B: Amounts of 32 mg of sodium percarbonate, 300 μL of sodium hydrogencarbonate solution B, 100 μL calcium-magnesium stock solution, 100 μL 1 M NaOH and 20.1 mg of NOBS were added to 40 mL of a 10 mM sodium carbonate:sodium hydrogencarbonate 1:1 buffer. This mixture was left to react under stirring at ambient temperature for 20 min.

Bleach cocktail 1B: Amounts of 63 mg of sodium percarbonate, 300 μL of sodium hydrogencarbonate solution B, 100 μL calcium-magnesium stock solution, 100 μL 1 M NaOH and 40.2 mg of NOBS were added to 40 mL of a 10 mM sodium carbonate:sodium hydrogencarbonate 1:1 buffer. This mixture was left to react under stirring at ambient temperature for 20 min. Preliminary experiments had shown that a maximum concentration of pernonanoic acid was reached with certainty after this time.

### Statistical Analysis

In this study the impact of four factors in the wash process according to the invention were investigated: Type of bleach (A or B); Concentration of bleach (0, ½ or 1); Time2 (bleach soak time is 0, 5 or 10 min) and Time3 (main wash time is 10 or 20 min). A day factor was also included as it was not possible to conduct all the runs in one day. The initial model for all stains was:

$$Rem = {\hat{β}}_{0} + {\hat{β}}_{1} conc + {\hat{β}}_{2} time 2 + {\hat{β}}_{3} time 3 + {\hat{β}}_{4} bleach + {\hat{β}}_{12} conc time 2 + {\hat{β}}_{13} conc time 3 + {\hat{β}}_{14} conc bleach + {\hat{β}}_{23} time 2 time 3 + {\hat{β}}_{24} time 2 bleach + {\hat{β}}_{34} time 3 bleach + {\hat{β}}_{11} {conc}^{2} + {\hat{β}}_{22} time {2}^{2} + day \& random + residual$$

Each stain type was analysed in one model as shown in the tables below which only includes significant terms and estimates of the parameters βᵢⱼ that are statistically significantly different from zero at a level of 5 percent or less. In some models the residuals were not normally distributed as they displayed a more ‘thick’ tail and thereby had a higher kurtosis than a normal distribution. Some models did not include the day&random term and were therefore analysed as a Generalized Linear Model (GLM) whereas models including the day&random term were analysed as mixed models. The statistical software used was JMP version 8.0.2 (see e.g. w/w.jmp.com).

The tracer swatches are not dealt with below. They were included in order to be able to check whether significant redeposition had taken place under the washes performed. This was not considered to be the case.

TABLE 3A
Parameter Estimates for wfk10J, tea on cotton: The overall conclusion
on this model is that the longer washing time, the cleaner the stain gets.
Time2 and Time3 have positive significant impact on the stain. The
residuals do not appear normally distributed.

| Term | Estimate | Std Error | t Ratio | Prob > \|t\| |
|---|---|---|---|---|
| Intercept | 44.524366 | 0.583549 | 76.30 | <.0001* |
| Conc | −0.739179 | 0.288583 | −2.56 | 0.0112* |
| Time2 | 0.2271444 | 0.028858 | 7.87 | <.0001* |
| Time3 | 0.1213511 | 0.025932 | 4.68 | <.0001* |
| Bleach[A] | 0.8833238 | 0.129574 | 6.82 | <.0001* |
| (Conc-0.48958) * | 0.2945625 | 0.063313 | 4.65 | <.0001* |
| (Time2-4.89583) | | | | |
| (Conc-0.48958) * | 2.19321 | 0.287501 | 7.63 | <.0001* |
| Bleach[A] | | | | |
| (Time2-4.89583) * | 0.1849195 | 0.02875 | 6.43 | <.0001* |
| Bleach[A] | | | | |
| (Conc-0.48958) * | 3.0578613 | 1.330659 | 2.30 | 0.0227* |
| (Conc-0.48958) | | | | |
| (Time2-4.89583) * | 0.0397521 | 0.013307 | 2.99 | 0.0032* |
| (Time2-4.89583) | | | | |

TABLE 3B
Parameter Estimates for EMPA167, tea on cotton: The overall
conclusion on this model is that the longer washing time, the
cleaner the stain gets. Time2 and Time3 have positive significant
impact on the stain. The residuals do not appear normally distributed.

| Term | Estimate | Std Error | t Ratio | Prob > \|t\| |
|---|---|---|---|---|
| Intercept | 25.08124 | 0.414441 | 60.52 | <.0001* |
| Conc | 3.3207322 | 0.262219 | 12.66 | <.0001* |
| Time2 | 0.1525344 | 0.026222 | 5.82 | <.0001* |
| Time3 | 0.1250554 | 0.023665 | 5.28 | <.0001* |
| Bleach[A] | 1.6155133 | 0.118137 | 13.67 | <.0001* |
| (Conc-0.48958) * | 0.271625 | 0.057791 | 4.70 | <.0001* |
| (Time2-4.89583) | | | | |
| (Conc-0.48958) * | 2.9265265 | 0.26215 | 11.16 | <.0001* |
| Bleach[A] | | | | |
| (Time2-4.89583) * | 0.1301388 | 0.026215 | 4.96 | <.0001* |
| Bleach[A] | | | | |
| (Time3-15.2083) * | 0.07669 | 0.023665 | 3.24 | 0.0014* |
| Bleach[A] | | | | |

TABLE 3C
Parameter Estimates for wfk10K, coffee: The overall conclusion on
this model is that the longer washing time, the cleaner the stain gets.
Time2 and Time3 have positive significantimpact on the stain. The
residuals appear normally distributed.

| Term | Estimate | Std Error | t Ratio | Prob > \|t\| |
|---|---|---|---|---|
| Intercept | 60.298208 | 0.44088 | 136.77 | <.0001* |
| Conc | 1.8754072 | 0.277522 | 6.76 | <.0001* |
| Time2 | 0.0684248 | 0.027686 | 2.47 | 0.0155* |
| Time3 | 0.1117438 | 0.025123 | 4.45 | <.0001* |
| Bleach[A] | 0.7375902 | 0.124716 | 5.91 | <.0001* |
| (Conc-0.48958) * | 0.2667088 | 0.061175 | 4.36 | <.0001* |
| (Time2-4.89583) | | | | |
| (Conc-0.48958) * | 1.2906893 | 0.277402 | 4.65 | <.0001* |
| Bleach[A] | | | | |
| (Time2-4.89583) * | 0.0667316 | 0.027668 | 2.41 | 0.0180* |
| Bleach[A] | | | | |
| Day[1] | 0.3638766 | 0.216712 | 1.68 | 0.0968 |
| Day[2] | 0.8069741 | 0.217345 | 3.71 | 0.0004* |
| Day[3] | −0.494964 | 0.219349 | −2.26 | 0.0266* |

TABLE 3D
Parameter Estimates for EMPA114, red wine on cotton: The
overall conclusionon this model is that the longer the washing
time, the cleaner the stain gets. Time2 and Time3 have positive
significant impact on the stain. The residuals appear normally
distributed.

| Term | Estimate | Std Error | t Ratio | Prob > \|t\| |
|---|---|---|---|---|
| Intercept | 53.504464 | 0.520173 | 102.86 | <.0001* |
| Conc | 1.2951174 | 0.257713 | 5.03 | <.0001* |
| Time2 | 0.1573115 | 0.025716 | 6.12 | <.0001* |
| Time3 | 0.1218937 | 0.023215 | 5.25 | <.0001* |
| Bleach[A] | 0.2492406 | 0.115318 | 2.16 | 0.0335* |
| (Conc-0.48958) * | 0.2104842 | 0.056488 | 3.73 | 0.0004* |
| (Time2-4.89583) | | | | |
| (Time2-4.89583) * | 0.0647217 | 0.025577 | 2.53 | 0.0133* |
| Bleach[A] | | | | |
| (Conc-0.48958) * | 2.3883615 | 1.185922 | 2.01 | 0.0472* |
| (Conc-0.48958) | | | | |
| (Time2-4.89583) * | −0.032959 | 0.011986 | −2.75 | 0.0073* |
| (Time2-4.89583) | | | | |
| Day[1] | 0.6448044 | 0.200324 | 3.22 | 0.0018* |
| Day[2] | −0.287936 | 0.202041 | −1.43 | 0.1578 |
| Day[3] | −0.330524 | 0.204195 | −1.62 | 0.1093 |

TABLE 3E
Parameter Estimates for CS-3, wine (aged): The overall conclusion
on this model is that the longer washing time, the cleaner the stain gets.
Time2 and Time3 have positive significant impact on the stain. The
residuals do not appear normally distributed.

| Term | Estimate | Std Error | t Ratio | Prob > \|t\| |
|---|---|---|---|---|
| Intercept | 46.923392 | 0.707042 | 66.37 | <.0001* |
| Conc | 2.5884928 | 0.386891 | 6.69 | <.0001* |
| Time2 | 0.1109929 | 0.038488 | 2.88 | 0.0050* |
| Time3 | 0.2541741 | 0.034913 | 7.28 | <.0001* |
| Bleach[A] | 1.6945828 | 0.173238 | 9.78 | <.0001* |
| (Conc-0.48958) * | 2.6811853 | 0.385281 | 6.96 | <.0001* |
| Bleach[A] | | | | |
| (Time2-4.89583) * | 0.1508357 | 0.038468 | 3.92 | 0.0002* |
| Bleach[A] | | | | |
| (Time3-15.2083) * | 0.1295003 | 0.034881 | 3.71 | 0.0004* |
| Bleach[A] | | | | |
| (Conc-0.48958) * | −4.670761 | 1.783885 | −2.62 | 0.0105* |
| (Conc-0.48958) | | | | |
| Day[1] | −0.166154 | 0.300468 | −0.55 | 0.5817 |
| Day[2] | −0.220355 | 0.302533 | −0.73 | 0.4684 |
| Day[3] | −0.733862 | 0.30551 | −2.40 | 0.0185* |

TABLE 3F
Parameter Estimates for wfk10WB, blueberry juice: Time 2 has an
optimum around 5 min soak time, whereas Time3 should be 20 min
in order to get the cleanest stain. The residuals do not appear
normally distributed.

| Term | Estimate | Std Error | t Ratio | Prob > \|t\| |
|---|---|---|---|---|
| Intercept | 44.77141 | 0.637823 | 70.19 | <.0001* |
| Conc | 3.6886575 | 0.349059 | 10.57 | <.0001* |
| Time2 | 0.1182756 | 0.034981 | 3.38 | 0.0009* |
| Time3 | 0.1956745 | 0.031479 | 6.22 | <.0001* |
| Bleach[A] | 2.0899524 | 0.157246 | 13.29 | <.0001* |
| (Conc-0.48958) * | 4.1729075 | 0.349059 | 11.95 | <.0001* |
| Bleach[A] | | | | |
| (Time2-4.89583) * | −0.017106 | 0.006973 | −2.45 | 0.0151* |
| (Time3-15.2083) | | | | |
| (Time3-15.2083) * | 0.0938388 | 0.031509 | 2.98 | 0.0033* |
| Bleach[A] | | | | |
| (Time2-4.89583) * | −0.041675 | 0.016157 | −2.58 | 0.0107* |
| (Time2-4.89583) | | | | |

TABLE 3G
Parameter Estimates for CS-11, redcurrant juice: Time 2 has positive
significant impact on how clean the stain gets. The maximal stain
reduction is with Time3 at 10 min and Time2 at 10 min. The residuals
appear normally distributed.

| Term | Estimate | Std Error | t Ratio | Prob > \|t\| |
|---|---|---|---|---|
| Intercept | 32.470096 | 0.450474 | 72.08 | <.0001* |
| Conc | 3.4998339 | 0.246492 | 14.20 | <.0001* |
| Time2 | 0.1356337 | 0.024712 | 5.49 | <.0001* |
| Time3 | 0.0412567 | 0.022216 | 1.86 | 0.0667 |
| Bleach[A] | 1.692574 | 0.111043 | 15.24 | <.0001* |
| (Conc-0.48958) * | 0.2098125 | 0.054271 | 3.87 | 0.0002* |
| (Time2-4.89583) | | | | |
| (Conc-0.48958) * | 3.5721894 | 0.246427 | 14.50 | <.0001* |
| Bleach[A] | | | | |
| (Time2-4.89583) * | −0.016274 | 0.004924 | −3.30 | 0.0014* |
| (Time3-15.2083) | | | | |
| (Time2-4.89583) * | 0.0671221 | 0.024621 | 2.73 | 0.0078* |
| Bleach[A] | | | | |
| (Time2-4.89583) * | 0.0245393 | 0.011396 | 2.15 | 0.0341* |
| (Time2-4.89583) | | | | |

TABLE 3H
Parameter Estimates for wfk10U, curry on cotton: Time2 does
not have a significant impact on the stain, however Time3 does.
Time3 should be 20 min in order to get the stain as clean as
possible. The residuals appear normally distributed.

| Term | Estimate | Std Error | t Ratio | Prob > \|t\| |
|---|---|---|---|---|
| Intercept | 57.209932 | 0.311782 | 183.49 | <.0001* |
| Conc | 2.8454072 | 0.20504 | 13.88 | <.0001* |
| Time3 | 0.1173062 | 0.01856 | 6.32 | <.0001* |
| Bleach[A] | 0.9025331 | 0.092109 | 9.80 | <.0001* |
| (Conc-0.48958) * | 1.0619072 | 0.20504 | 5.18 | <.0001* |
| Bleach[A] | | | | |
| (Time3-15.2083) * | 0.0499435 | 0.018526 | 2.70 | 0.0084* |
| Bleach[A] | | | | |
| Day[1] | −0.632786 | 0.159798 | −3.96 | 0.0002* |
| Day[2] | 0.7853833 | 0.159795 | 4.91 | <.0001* |
| Day[3] | −0.56215 | 0.162281 | −3.46 | 0.0008* |

TABLE 3I
Parameter Estimates for CS-20, tomato: The cleanest stains
are obtained by Time2 equal to 10 min and Time3 equal to 20 min.
The residuals appear normally distributed.

| Term | Estimate | Std Error | t Ratio | Prob > \|t\| |
|---|---|---|---|---|
| Intercept | 52.201718 | 0.333368 | 156.59 | <.0001* |
| Conc | 3.6884216 | 0.18253 | 20.21 | <.0001* |
| Time2 | 0.1535049 | 0.018155 | 8.46 | <.0001* |
| Time3 | 0.1301748 | 0.016462 | 7.91 | <.0001* |
| Bleach[A] | 1.012121 | 0.081731 | 12.38 | <.0001* |
| (Conc-0.48958) * | 0.0904446 | 0.040063 | 2.26 | 0.0252* |
| (Time2-4.89583) | | | | |
| (Conc-0.48958) * | 1.4311931 | 0.181666 | 7.88 | <.0001* |
| Bleach[A] | | | | |
| (Conc-0.48958) * | −5.347191 | 0.839655 | −6.37 | <.0001* |
| (Conc-0.48958) | | | | |
| Day[1] | −0.159018 | 0.142001 | −1.12 | 0.2643 |
| Day[2] | 0.4005516 | 0.142916 | 2.80 | 0.0056* |
| Day[3] | −0.690928 | 0.143595 | −4.81 | <.0001* |

TABLE 3J
Parameter Estimates for wfk10P, red pepper: Time2 does not have
a significant impact on the stain, however Time3 does. Time3 should
be 20 min in order to get the stain as clean as possible. The residuals
do not appear normally distributed.

| Term | Estimate | Std Error | t Ratio | Prob > \|t\| |
|---|---|---|---|---|
| Intercept | 58.907157 | 0.592992 | 99.34 | <.0001* |
| Conc | 1.9217697 | 0.389737 | 4.93 | <.0001* |
| Time3 | 0.0740192 | 0.035277 | 2.10 | 0.0388* |
| Bleach[A] | 0.6988291 | 0.175216 | 3.99 | 0.0001* |
| (Conc-0.48958) * | 0.2052685 | 0.078298 | 2.62 | 0.0103* |
| (Time3-15.2083) | | | | |
| (Conc-0.48958) * | 1.2020054 | 0.389676 | 3.08 | 0.0027* |
| Bleach[A] | | | | |
| Day[1] | −0.769153 | 0.305299 | −2.52 | 0.0136* |
| Day[2] | 0.335559 | 0.304011 | 1.10 | 0.2727 |
| Day[3] | −1.145057 | 0.30937 | −3.70 | 0.0004* |

TABLE 3K
Parameter Estimates for CS-60, spaghetti sauce (with beef): Time 2
has an optimum around 5 min soak time, whereas Time3 should be
20 min in order to get the cleanest stain. One observation was removed
as an outlier. The residuals appear normally distributed.

| Term | Estimate | Std Error | t Ratio | Prob > \|t\| |
|---|---|---|---|---|
| Intercept | 67.12185 | 0.351927 | 190.73 | <.0001* |
| Conc | 3.4959357 | 0.144884 | 24.13 | <.0001* |
| Time2 | 0.0154546 | 0.014435 | 1.07 | 0.2874 |
| Time3 | 0.0532549 | 0.012922 | 4.12 | <.0001* |
| Bleach[A] | 0.9608427 | 0.064244 | 14.96 | <.0001* |
| (Conc-0.48421) * | 1.5714411 | 0.142962 | 10.99 | <.0001* |
| Bleach[A] | | | | |
| (Conc-0.48421) * | −4.297031 | 0.657007 | −6.54 | <.0001* |
| (Conc-0.48421) | | | | |
| (Time2-4.84211) * | −0.029654 | 0.006663 | −4.45 | <.0001* |
| (Time2-4.84211) | | | | |

TABLE 3L
Parameter Estimates for EMPA164, grass on cotton: Time 2 has
an optimum around 7.2 min soak time whereas Time3 should be
20 min in order to get the cleanest stain. The residuals do
not appear normally distributed.

| Term | Estimate | Std Error | t Ratio | Prob > \|t\| |
|---|---|---|---|---|
| Intercept | 40.663255 | 0.532865 | 76.31 | <.0001* |
| Conc | 3.3393016 | 0.291526 | 11.45 | <.0001* |
| Time2 | 0.2112087 | 0.029224 | 7.23 | <.0001* |
| Time3 | 0.1025164 | 0.026282 | 3.90 | 0.0001* |
| Bleach[A] | 1.038446 | 0.131325 | 7.91 | <.0001* |
| (Conc-0.48958) * | 1.3030516 | 0.291526 | 4.47 | <.0001* |
| Bleach[A] | | | | |
| (Time2-4.89583) * | 0.1398277 | 0.029116 | 4.80 | <.0001* |
| Bleach[A] | | | | |
| (Time2-4.89583) * | −0.077549 | 0.013482 | −5.75 | <.0001* |
| (Time2-4.89583) | | | | |

TABLE 3M
Parameter Estimates for EMPA116, blood-milk-ink on cotton:
Time 3 does not have significant impact on the cleaning of this
stain - however, Time 2 does have positive significant impact.
The residuals appear normally distributed however this model
has a very high unexplained variance.

| Term | Estimate | Std Error | t Ratio | Prob > \|t\| |
|---|---|---|---|---|
| Intercept | 27.204419 | 1.12283 | 24.23 | <.0001* |
| Conc | 1.5674823 | 0.754491 | 2.08 | 0.0407* |
| Time2 | 0.2285912 | 0.075228 | 3.04 | 0.0031* |
| Bleach[A] | 0.4510113 | 0.33921 | 1.33 | 0.1871 |
| (Conc-0.48958) * | 3.1004823 | 0.754491 | 4.11 | <.0001* |
| Bleach[A] | | | | |

TABLE 3N
Parameter Estimates for C-S-101, blood, slightly aged: Time 3 does
not have significant impact on the cleaning of this stain - however
Time 2 does have positive significant impact. The residuals appear
normally distributed however this model has a very high unexplained
variance.

| Term | Estimate | Std Error | t Ratio | Prob > \|t\| |
|---|---|---|---|---|
| Intercept | 17.430301 | 0.472118 | 36.92 | <.0001* |
| Conc | 1.9678232 | 0.571768 | 3.44 | 0.0009* |
| Time2 | 0.3842165 | 0.057177 | 6.72 | <.0001* |
| Bleach[A] | 0.6502205 | 0.25783 | 2.52 | 0.0134* |
| (Conc-0.48958) * | 2.5763232 | 0.571768 | 4.51 | <.0001* |
| Bleach[A] | | | | |
| (Time2-4.89583) * | −0.124433 | 0.057177 | −2.18 | 0.0322* |
| Bleach[A] | | | | |

TABLE 3O
Parameter Estimates for EMPA112, milk-cocoa on cotton: The
cleaneststains are obtained by Time 2 equal to 10 min and
Time 3 equal to 20 minutes. The residuals do not appear
normally distributed.

| Term | Estimate | Std Error | t Ratio | Prob > \|t\| |
|---|---|---|---|---|
| Intercept | 33.009931 | 0.675752 | 48.85 | <.0001* |
| Conc | 3.9297458 | 0.427538 | 9.19 | <.0001* |
| Time2 | 0.3219289 | 0.042734 | 7.53 | <.0001* |
| Time3 | 0.2931192 | 0.038555 | 7.60 | <.0001* |
| Bleach[A] | 1.3017996 | 0.192775 | 6.75 | <.0001* |
| (Conc-0.48958) * | 0.2091661 | 0.085534 | 2.45 | 0.0164* |
| (Time3-15.2083) | | | | |
| (Conc-0.48958) * | 2.8841695 | 0.427668 | 6.74 | <.0001* |
| Bleach[A] | | | | |

Conclusion:

It is apparent that presence of the second soak step (i.e., T2>0 min) in the wash process according to the invention has a significant positive impact. It is not possible to obtain one single model that describes the optimum wash conditions for all stains. However, in general, within the ranges of the factors varied in this study, the best wash conditions for most stains were obtained by using TAED (bleach cocktail 1A), T2=10 min and T3=20 min.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1-15. (canceled)

16. A method for cleaning an object comprising the steps:
(a) distributing to the object a first soak solution comprising at least one surfactant and at least one enzyme followed by a first soak period wherein the concentrations of the at least one surfactant and the at least one enzyme are higher relative to their concentrations in a subsequent wash solution;
(b) adding to the object a second soak solution comprising at least one component that is different from any of the components comprised in the soak solution of (a) followed by a second soak period;
(c) furthermore adding to the object water to obtain a wash solution followed by a wash period; and
(d) rinsing the object;
wherein step (b) is conducted either before or after step (c), and wherein said method has a wash performance corresponding to any of (i) a Relative Wash Performance (RWP) of at least 1; (ii) a Process Related Cleaning Index (PRCI) of more than 1; or (iii) a Relative Wash Performance (RWP) of at least 1 and a Process Related Cleaning Index (PRCI) of more than 1.

17. The method of claim 16, wherein the at least one component is selected from the group containing: bleaching system components, proteases, and polymers.

18. The method of claim 17, wherein bleaching system components include bleaching catalysts, photobleaches, bleach activators, hydrogen peroxide, preformed peracids and mixtures thereof.

19. The method of claim 16, wherein no agitation or other mechanical action is applied during the soak period after the initial agitation for the purpose of distributing the soak solution and wetting the object.

20. The method of claim 16, wherein the concentration of the at least one enzyme in the wash solution is obtained by diluting the soak solution with a factor of at least 1, 2, 3, 4, 5, 6, 7, 8, 9, 10, 11, 12, 13, 14, 15, 16, 17, 18, 19, or 20.

21. The method of claim 16, wherein the soak period is from 1 to 120 minutes.

22. The method of claim 16, wherein the wash period is from 5 to 120 minutes.

23. The method of claim 16, wherein the first soak period and/or the second soak period and/or the wash period individually is conducted at a temperature below 40° C.

24. The method of claim 16, wherein the at least one enzyme is selected from the group consisting of: hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, and amylases, or any combination thereof.

25. The method of claim 24, wherein the at least one enzyme is a mixture comprising an amylase, a cellulase, a lipase and a protease.

26. The method of claim 16, wherein the at least one enzyme is used at an amount from 0 to 20 milligrams enzyme protein per gram textile.

27. The method of claim 16, wherein the at least one surfactant is selected from the group consisting of: anionic surfactants; cationic surfactants; zwitterionic surfactants; amphoteric surfactants; nonionic surfactants or any combinations thereof.

28. The method of claim 16, wherein the concentration of the at least one surfactant is from 0 to 500 milligrams per gram textile.

29. The method of claim 16, wherein the object is fabric/textile.
